(19) United States
(12) Patent Application Publication
(10) Pub. No.: US 2026/0105143 A1
(43) Pub. Date: Apr. 16, 2026

(54) SYSTEM AND METHOD FOR MONITORING CPU INSTRUCTION AND DATA STREAMS

(71) Applicant: Georgia Tech Research Corporation, Atlanta, GA (US)

(72) Inventors: Sukarno MERTOGUNO, Atlanta, GA (US); Pak Ho CHUNG, Atlanta, GA (US)

(21) Appl. No.: 19/357,391

(22) Filed: Oct. 14, 2025

Related U.S. Application Data
(60) Provisional application No. 63/707,650, filed on Oct. 15, 2024.

(51) Int. Cl. G06F 21/52; G06F 21/57

(52) U.S. Cl. CPC G06F 21/52; G06F 21/577; G06F 2221/034

(57) ABSTRACT

An exemplary system and method for instruction-level monitoring of software execution by a processor using hardware programmable state machines to enforce program execution safety and detect the exploitation of software vulnerabilities in real time. The instruction-level monitoring maintains a hardware programmable state machine for a number of states that is configured to observe, e.g., for states of interest and data values of the states, associated with a safety or software vulnerabilities. In some embodiments, the exemplary system and method are implemented as a dedicated co-processor in a computing system, that incrementally add a small overhead to the processor, to (i) monitor every instruction and (ii) halts execution of instructions upon detecting anomalies before the anomalies are executed and start exploiting the system vulnerabilities.

### RELATED APPLICATION

This application claims priority to, and the benefit of, U.S. Provisional Patent Application No. 63/707,650, filed Oct. 15, 2024, entitled “INSTRUCTION AND DATA STREAMS MONITORING FOR CPU,” which is incorporated by reference herein in its entirety.

### GOVERNMENT SPONSORSHIP CLAUSE

This invention was made with government support under D22AC00123-00, awarded by the Department of the Interior. The government has certain rights in the invention.

### BACKGROUND

System security monitors can observe and analyze system behavior to detect potential threats or anomalies. Security monitors can operate at various levels of abstraction, depending on the types of events they are configured to observe.

Instruction-level monitoring can observe the execution of individual machine instructions being executed by a processor. The method is often employed in an offline analysis to analysis of program behavior and to detect subtle or low-level attack patterns. Instruction-level monitoring are used in chip designs, root-cause specialized security analysis and in researchtp identify new behavioral anomalies. Real-time instruction-level monitoring on a processor would require the monitoring circuit to perform multiple of times faster than the processor under monitor.

There is a benefit to improving the system and method for monitoring the security of and vulnerabilities in current computing systems, in particular, by providing instruction-level monitoring more ubiquitously.

### SUMMARY

An exemplary system and method are disclosed for instruction-level monitoring of software execution by a processor using hardware programmable state machines (referred to herein as “statelets”), to enforce program execution safety and detect the exploitation of software vulnerabilities in real time. The instruction-level monitoring maintains a hardware programmable state machine for a number of states that is configured to observe, e.g., for states of interest and data values of the states, associated with a safety or software vulnerabilities. In some embodiments, the exemplary system and method are implemented as a dedicated co-processor in a computing system (e.g., RISC-V system-on-chip, CISC, etc.), that incrementally add a small overhead to the processor, to (i) monitor every instruction and (ii) halts execution of instructions upon detecting anomalies before the anomalies are executed and start exploiting the system vulnerabilities.

Different from current security monitoring systems (e.g., Control Flow Integrity (CFI), Intel Processor Trace (PT)) that monitor a limited subset of instructions and are constrained to detect specific classes of attacks, the exemplary system and method analyze all instructions to detect the exploitation of vulnerabilities (e.g., buffer overflows, use-after-free/double-free, integer overflows, etc.) before they corrupt system's state. While current software-based instruction-level monitoring incurs prohibitive overhead (e.g., requiring 17 instructions to process each monitored instruction), resulting in over 1700% slowdown, the exemplary system and method can overcome this limitation by offloading monitoring tasks to a dedicated hardware co-processor. In one example, an implemented configuration was able to provide efficient, real-time analysis of every instruction with minimal resource impact, achieving only 5% area and power overhead and no slowdown to the main processor's execution. The exemplary system and method are updatable to address new vulnerabilities.

The exemplary system and method can enforce safety protocols and detect vulnerability exploitation based on execution patterns (e.g., computing system or model's behaviors) at an instruction level and for all instructions being executed by a processor. The localized approach can identify and respond to individual exploit behaviors as well as broad, global policies. As a result, the exemplary system and method can provide a practical defense against existing and newly discovered vulnerabilities in the absence of available patches.

In an aspect, a processor is disclosed comprising: one or more processing unit, each configured to execute CPU instructions for a software program or process; and an instruction-level programmable processor probing circuit operatively coupled to at least one of the one or more processing unit to detect an instruction-level anomaly at a processing unit under monitor, the instruction-level programmable processor probing circuit comprising: one or more state-machine engines having a plurality of programmable states to detect the instruction-level anomalies performed by the one or more processing unit, each state-machine engine having (i) a state table and (ii) a digital logic circuit configured to employ contents of the corresponding state table, wherein each state table has a plurality of rows or columns corresponding to monitored states for a computer program or process being executed by the processing unit under monitor, the state table having a set of states for a number of instruction-level anomaly, each state having a plurality of entries having content for a functional operation to be performed by the digital logic circuit, wherein each digital logic circuit is configured, for each instruction cycle of the processing unit under monitor, to (i) execute a functional operation defined by the plurality of entries, or a portion thereof, for a given state of a given instruction-level anomaly and (ii) determine and transition to a next state in the state table once a transition condition is met, and wherein the instruction-level programmable processor probing circuit is configured to output a signal for an instruction-level anomaly and/or trigger halt of execution of instructions by the respective processing unit upon detection of the instruction-level anomaly by the state-machine engine.

In some embodiments, the instruction-level programmable processor probing circuit includes an i-state machine configured to monitor states of interest in the execution of the monitored program; and a d-state machine for monitoring data values involved in the execution of a monitored program, each of the i-state machine and d-data machine having a state table and digital logic circuit.

In some embodiments, the instruction-level programmable processor probing circuit is configured as a multi-stage pipeline configured to operate in a continuous manner per instruction cycle for a CPU instruction in a data stream of CPU instructions, the multi-stage pipeline including: a first stage circuit configured to fetch, in a given instruction cycle, a next CPU instruction from a state table of a state-machine engine in the one or more state-machine engines; a second stage circuit configured to load, in the same given instruction cycle or in a next instruction cycle, a plurality of entries, or a portion thereof, for a given state of a given instruction-level anomaly to the digital logic circuit (e.g., by loading the fields (e.g., instruction address, data and register index, etc.) of the next CPU instruction into corresponding registers in the digital logic circuit of the state-machine engine); and a third stage circuit to execute, in the same given instruction cycle or within next two cycles, the digital logic circuit to execute a functional operation defined by the digital logic circuit and a plurality of entries, or a portion thereof, for a given state of a given instruction-level anomaly.

In some embodiments, the instruction-level programmable processor probing circuit is configured to transition to a next state based on two or more conditions.

In some embodiments, the instruction-level programmable processor probing circuit is configured to execute, for a branch CPU instruction, two evaluations of the two or more conditions for transition to the next state.

In some embodiments, each of the plurality of rows or columns corresponding to monitored states for a computer program or process includes: one or more transition conditions; a next state definition; and an action condition.

In some embodiments, the one or more state-machine engines include at least two state-machine engines, wherein each of the state-machine engine is synchronized with one another.

In some embodiments, the instruction-level programmable processor probing circuit is configured to monitor for invariant or consistent execution properties of a CPU instruction.

In some embodiments, the instruction-level programmable processor probing circuit is configured to halt CPU operation of the processing unit under monitor within 3-5 instruction cycles of detection of the instruction-level anomaly by the state-machine engine and while the anomaly is being executed by the one or more processing unit.

In some embodiments, the state table is implemented in register with the plurality of programmable states and plurality of entries having content for a functional operation stored in registers.

In some embodiments, a portion of the plurality of entries is compressed and a remaining portion of the plurality of entries is not compressed.

In some embodiments, the instruction-level programmable processor probing circuit is configured for a set of Common Vulnerabilities and Exposures (CVE) detections as the instruction-level anomaly.

In some embodiments, the instruction-level programmable processor probing circuit is configured for a set of Common Weakness Enumeration (CWE) detections as the instruction-level anomaly.

In some embodiments, the output signal for the instruction-level anomaly is employed for monitoring or model checking, detection, forensic and diagnostic, mitigation, recovery, or halt execution.

In some embodiments, the one or more state-machine engines include duplicates of the state-machine engines, including a first i-state machine, a second i-state machine, a first d-state machine, and a second d-state machine, wherein each of the state-machine engines is synchronized with one another.

In some embodiments, the digital logic circuit of the instruction-level programmable processor probing circuit includes: a comparator coupled to a mask register and a value register; a down counter circuit coupled to the comparator and a control register; and an update action circuit coupled to the down counter circuit and configured to output a output value to a pointer of an action table, the action table being monitored to execute an action at the one or more processing units.

In some embodiments, the multi-stage pipeline further includes: a ring buffer coupled to an output of the third stage circuit; and a direct memory access circuit coupled to the ring buffer, the direct memory access circuit being configured to output a data value to a memory controller.

In another aspect, a method is disclosed comprising: providing any one of the above-discussed processor; loading a plurality of CPU instructions into the processor, the plurality of CPU instructions being executed by the first processing unit; detecting, via one or more state-machine engines having the plurality of programmable states, one or more instruction-level anomalies in the plurality of CPU instructions; and outputting a signal for an instruction-level anomaly and/or trigger halt of execution of the plurality of instructions by the first processing unit upon detection of the instruction-level anomaly by the state-machine engine.

In another aspect, a method is disclosed for programming an instruction-level programmable processor probing circuit to detect an instruction-level anomaly at a processing unit, the method comprising: providing one or more state machines describing CPU instructions for a software program of interest executed by the processing unit, wherein the one or more state machines includes one or more transition conditions, a next state definition, and an action condition; converting states in the one or more state machines into programmable states (e.g., statelet) by translating references in the one or more state machines from source code locations to binary addresses, wherein the programmable states are linked via the one or more transition conditions; and loading the programmable states into a state table of the processor probing circuit, wherein the state table has a plurality of rows or columns corresponding to monitored states for the software program of interest, the state table having a set of states for a number of instruction-level anomaly, each state having a plurality of entries having content for a functional operation to be performed (e.g., by a digital logic circuit).

In some embodiments, the loading of the programmable states into the state table comprises: mapping each programmable state to a respective index of the state table (e.g., using a predefined mapping rule); and determining state table indices for the programmable states for instruction-level (i-) and data-level (d-) monitoring for the software program of interest.

In some embodiments, the method further includes storing the mapping in a memory (e.g., of a device driver), the memory being operatively coupled to the processing unit; and extracting the mapping from the memory to initiate monitoring of the software program of interest, in response to the software program of interest being subsequently launched.

### BRIEF DESCRIPTION OF DRAWINGS

FIGS. 1A-1C each shows an example system for detecting instruction-level anomalies at one or more processing units of a processor, in accordance with an illustrative embodiment.

FIGS. 1D-1F each shows an example multi-stage pipeline implementation of the exemplary system described in FIGS. 1A-1C.

FIG. 2A shows an example method of operating the exemplary system, in accordance with an illustrative embodiment.

FIGS. 2B-2D each shows an example method of programming the exemplary system, and an instruction-level programmable processor probing circuit thereof, in accordance with an illustrative embodiment.

FIG. 3A shows an example operational pipeline of the exemplary system that employs state machines and statelets, in accordance with an illustrative embodiment.

FIGS. 3B-3E each shows an example i-statelet, d-statelet, s-statelet, and hi-statelet, respectively, in accordance with an illustrative embodiment.

FIG. 4A shows an example operation flow for programming and/or loading the exemplary system, as described in relation to FIGS. 2B-2D.

FIG. 4B shows an example monitoring processor, having the exemplary system implemented thereon, configured to monitor a RISC-V processor.

FIG. 4C shows the state machine parameters for instruction monitoring (i-statelet), data monitoring (d-statelet), and the pseudocodes for the instruction and data monitoring, if implemented as software on a CPU.

FIGS. 5A-5E show example configurations of state machines and algorithms for the exemplary system to detect common vulnerabilities and exposures (CVEs).

FIG. 6A shows an algorithm for CVE-2018-12323 that was detected by an experimental system described in FIGS. 1A-1B.

FIG. 6B shows a state machine for detecting CVE-2017-9182 and CVE-2017-9196 by combining the state machines and individually detecting each CVE.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

As used herein, the term “state machine” refers to a computational behavior model having a finite number of states in which transitions between those states, and actions in association with the states, can describe the behavior of digital logic or software systems. A state machine operates by transitioning from one state to another in response to external inputs or internal conditions, and executing defined operations at each state. As used herein, the term “statelet” refers to a programmable hardware implementation of a time-sliced state machine, designed to perform online, instruction-level monitoring. The time slice corresponds to an instruction cycle, i.e., time for a processor to execute an instruction. A statelet, as programmable elements stored in a state table that is loaded into a hardware programmable circuit, encapsulates the functionality and behavior of a specific state within a state machine to monitor for processor vulnerabilities at a given clock cycle. Many state machines may be defined in the state table and loaded into the hardware programmable circuit based on specific instructions being executed by the processor. Statelets may be characterized as a processor instruction for a co-processor that executes in parallel to a main processor to determine if the main processor will exhibit or experience an anomalous event when executing a given processor instruction from an instruction stream. Multiple statelets may be executed in parallel or in combination with one another, where each is executing a sequence of statelet operations, collectively represent the full state machine. As the hardware programmable state machine transitions between states, the corresponding statelet program may also advance in synchrony. Statelets can perform pattern and event recognition in real time, and notify a security driver executing on a main processor, operating system, or other low-level processes of a computer when a suspicious or predefined event is detected.

### Example System

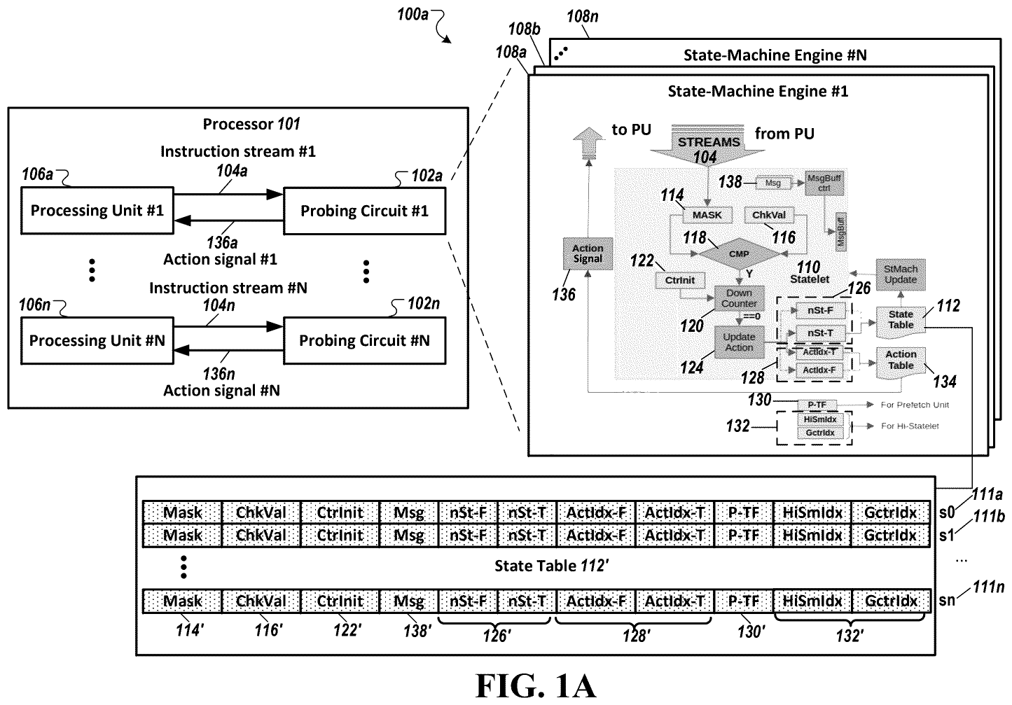

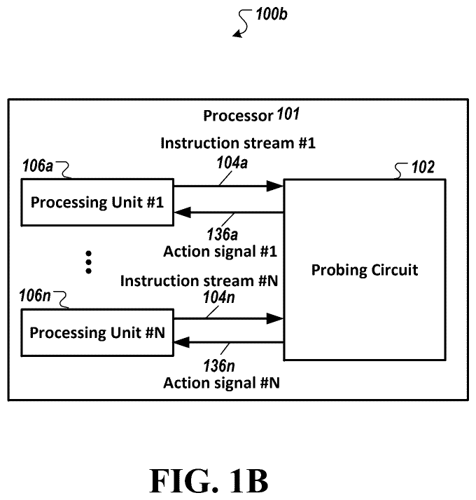

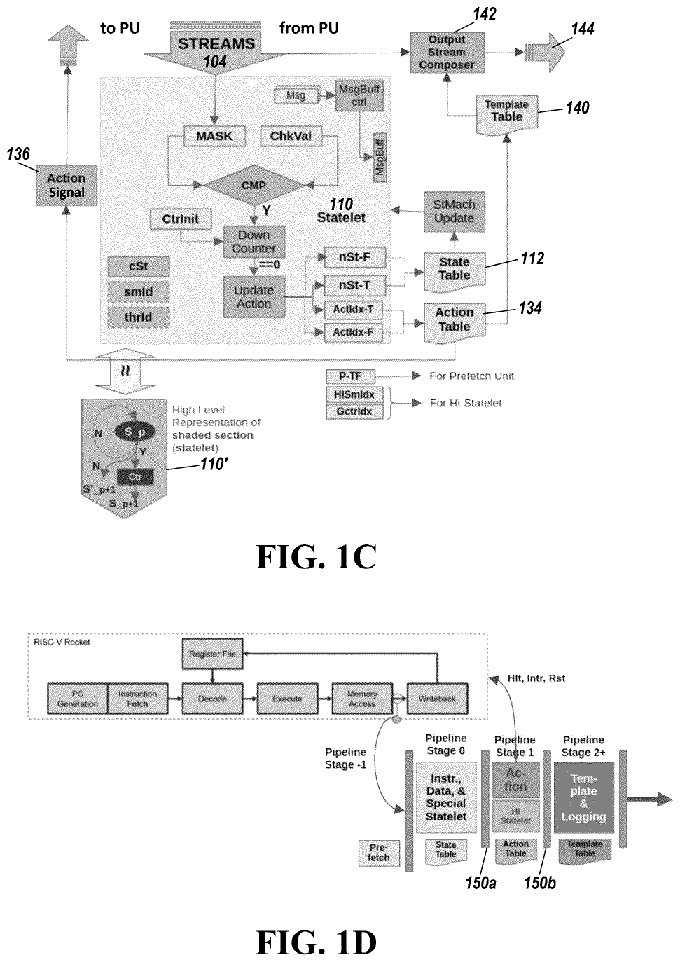

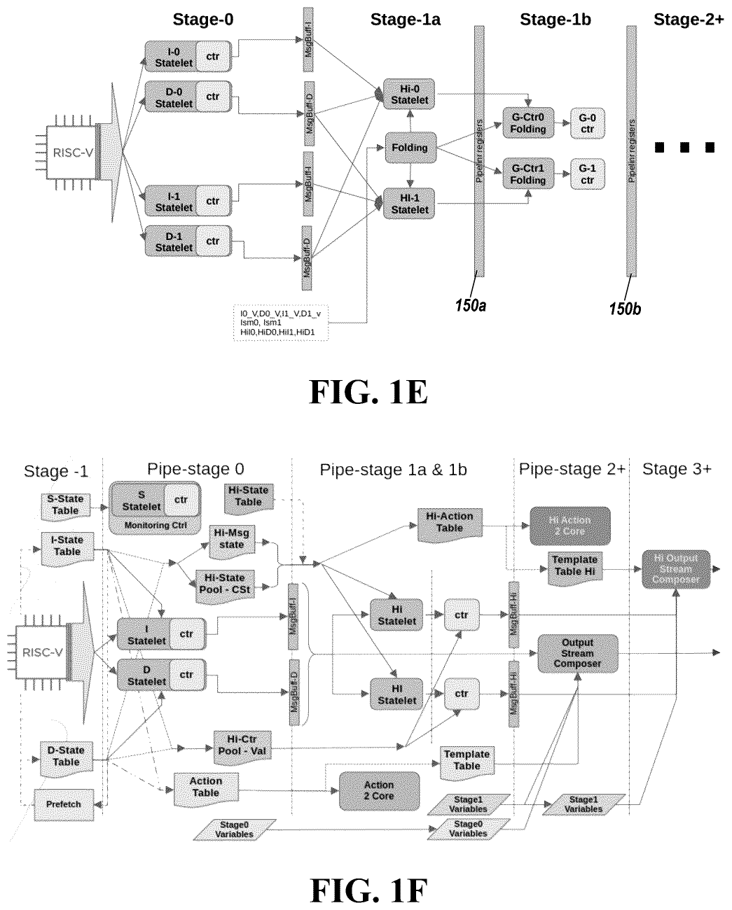

FIGS. 1A-1B each shows an example hardware programmable state machine system 100 (shown as 100a, 100b) for detecting instruction-level anomalies (e.g., common vulnerabilities and exposures (CVE)) at one or more processing units 106a-106n of a processor 101, in accordance with an illustrative embodiment. The exemplary system 100 includes one or more instruction-level programmable processor probing circuits 102a-102n (shown as probing circuits #1-#N) (e.g., co-processor), each configured to detect anomalies in CPU instruction streams 104a-104n for a software program that are executed by the one or more processing units 106a-106n. In the example shown in FIG. 1A, the system 100 includes a plurality of probing circuits 102a-102n, each operatively coupled to a processing unit (e.g., 106a-106n) of the processor 101. In FIG. 1B, the system 100 implements a central probing circuit 102 operatively coupled to all the processing units 106a-106n of the processor 101 or a subset of them.

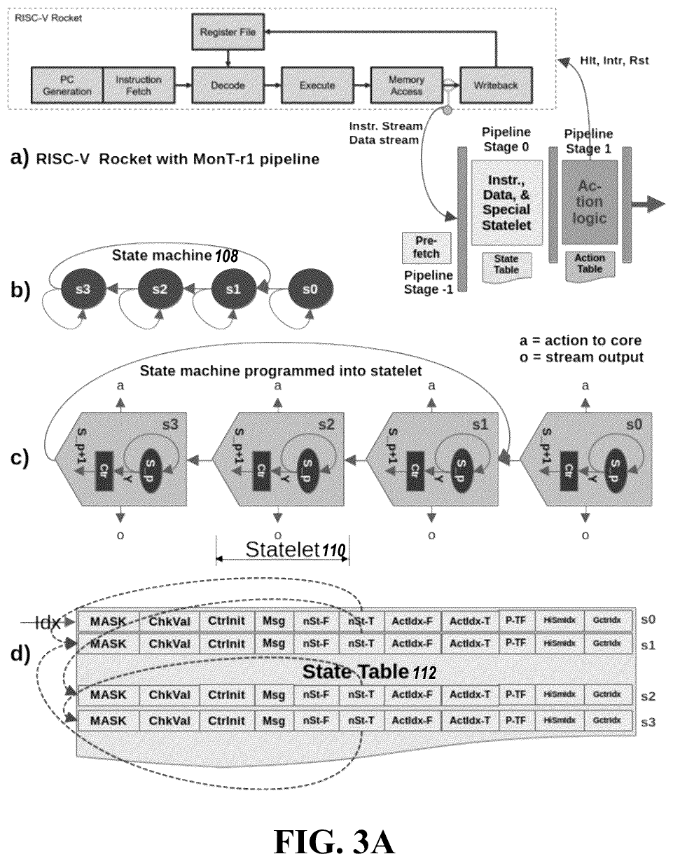

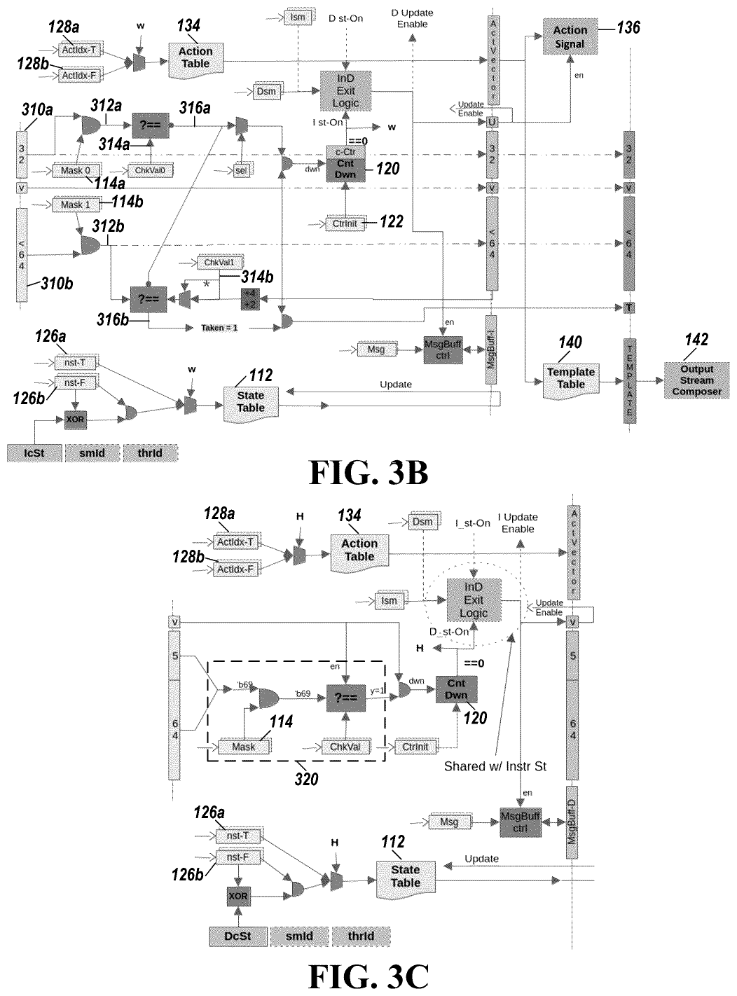

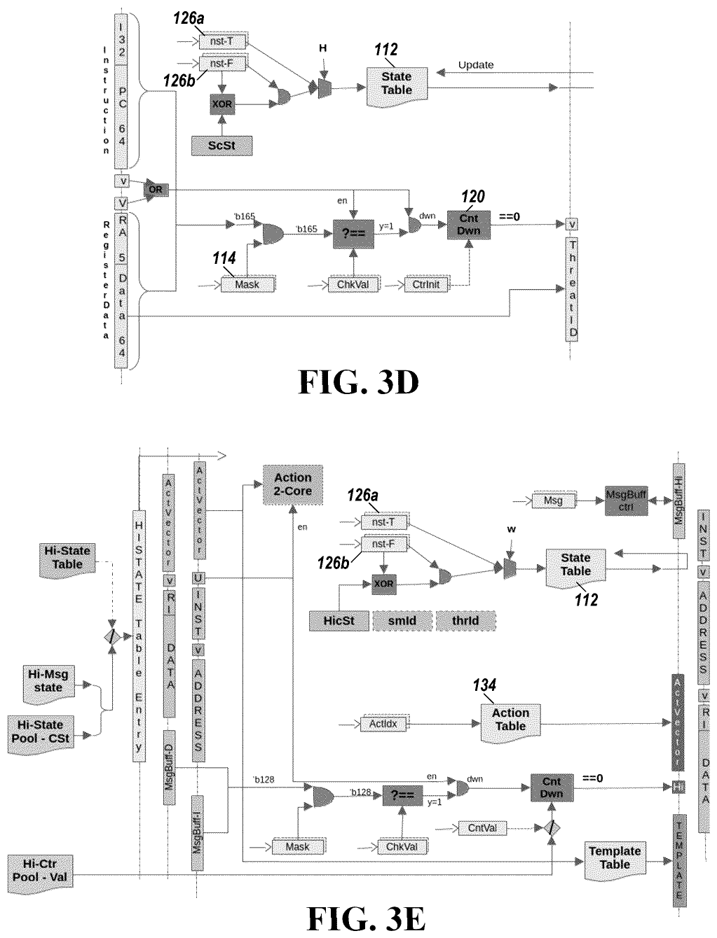

Instruction-Level Programmable Processor Probing Circuits (102). In the examples shown in FIGS. 1A-1B, a probing circuit 102 (e.g., 102a-102n) includes one or more state-machine engines 108a-108n (shown as state-machine engines #1-#N), each formed by one or more hardware programmable states 110 (e.g., statelet) (see FIG. 3A), where the hardware programmable states are loaded on to programmable hardware that can detect an instruction-level anomaly in a given instruction stream within a time slice corresponding to an instruction cycle for the processing units 106 (e.g., 106a-106n). Each state-machine engine 108 includes (i) a state table 112 (shown as 112′) having a set of states for a statelet and (ii) a digital hardware logic circuit 110 (shown as “statelet” 110) that operates with a statelet as an instance 111 (shown as state S₀ 111a, state S₁ 111b, . . . state Sₙ 111n) of the state table 112 to execute an operation defined by the statelet and the hardware logic circuit 112. An example of a statelet is a program via the state-machine engine to evaluate a baseAddress register for overflow monitoring. The digital hardware logic circuit 112 is configured to execute the statelet (contents via an instance of the state table). Statelets are not conventional computer-readable instructions or processor instructions. Rather, statelets may be characterized as a processor instruction for a processor that executes in parallel to another processor to determine if the processor will exhibit an anomalous event when executing a given processor instruction.

The state-machine engines 108 (e.g., 108a-108n) may be implemented to include an instruction-monitoring state machine (also referred to as an “i-state machine”), a data-monitoring state machine (also referred to as a “d-state machine”), an s-state machine, or a combination thereof, where the state-machine engines are synchronized with one another. In some embodiments, the i-state machine (e.g., i-statelet machine) is configured to monitor instructions of interest in the execution of a monitored software program (e.g., to provide support for control-flow-based monitoring of a target process). The d-state machine (e.g., d-statelet machine) is configured to monitor data values involved in the execution of the monitored software program (e.g., monitoring location and values of a written register). Each i-state machine and d-state machine may be implemented by a combination of a state table (e.g., 112) (e.g., i-statelet table, d-statelet table) and a digital logic circuit to execute a set of statelets.

In alternative embodiments, a single state-machine engine 108 may implement multiple state tables and corresponding digital logic circuit to execute them.

In FIGS. 1A-1B, the probing circuit 102 (e.g., 102a-102n), operatively coupled to the one or more processing units 106a-106n, (i) receives the CPU instruction streams 104a-104n from the one or more processing units 106 and (ii) analyzes the received CPU instruction streams 104a-104n to detect any instruction-level anomalies. During the analysis, the probing circuit 102 (e.g., 102a-102n) can use its (i) set of state-machine engines 108 (e.g., i-state, d-state, and s-state machines), and (ii) the statelets 110, a state table 112, and an action table 134 therein, to (a) find the anomalies, (n) determine a suitable action value (e.g., from the action table 134) to include in the action signal 136 for the processing unit 106, and (c) output the action signal 136 to the processing unit 106 and/or trigger halt of execution of the instruction streams in response to the anomalies. In some embodiments, the output signal (e.g., action signal 136) is employed for monitoring or model checking, detection, forensic and diagnostic, mitigation, recovery, or halt execution of an instruction in the received CPU instruction streams.

In some embodiments, the probing circuit 102 (e.g., 102a-102n) is configured for a set of common vulnerabilities and exposures (CVE) as the instruction-level anomaly (e.g., integer overflow, use-after-free, etc.). In some embodiments, the probing circuit 102 is configured for a set of common weakness enumeration (CWE) as the instruction-level anomaly (e.g., stack overflow). The probing circuit 102 is also configured to monitor invariant or consistent execution properties of a CPU instruction (e.g., “if variable s is set to value k at instruction I_{d}, its value should also be k when used at an instruction”, or “privileged instruction Iₚ should not be executed without executing instruction Iₐ that grants the current process the privilege”).

State Table (112). The state table 112 (shown as 112′) includes a plurality of rows or columns corresponding to monitored states (e.g., s0, s1, . . . , sn) for the software computer program being executed by the processing unit 106 (e.g., 106a-106n). The state table 112 includes a set of states (e.g., s0, s1, . . . , sn) for a number of instruction-level anomalies, where each state has a plurality of entries (e.g., 116′, 118′, 122′, 126′, 128′, 130′, 132′, 138′) containing content for a functional operation or register to be performed by the statelet 110 and its digital circuit. Specifically, each state table entry can contain (i) a field data or value to be loaded into corresponding registers in the statelet 110, including Mask value 114′ into a mask register 116, ChkVal value 116′ into a value register 118, CtrlInit value 122′ into a control initiate register 122, and Msg value 138′ into a message register 138, (ii) a pointer to another state table entry (or index), including next state pointers 126 (e.g., nSt-F, nSt-T) (shown as 126′), (iii) a pointer to an entry (or index) in the action table 134, including action index pointers 128 (e.g., ActInd-F, ActInd-T) (shown as 128′), (iv) a field data or value into a prefetch unit, including a P-TF value 130 (shown as 130′), and (v) a pointer to a hi-statelet, including HiSmIdx and GctrIdx pointers 132 (shown as 132′).

In some embodiments, the P-TF value 130 carries a prediction value: predict-True or predict-False. If predict-True (P-TF=1), the prefetch unit may fetch nSt-T first, then prefetch nSt-F in a subsequent cycle. If predict-False (P-TF=0), the prefetch unit may prefetch nSt-F first, then prefetch nSt-T in a subsequent cycle.

In some embodiments, the state table 112 is implemented in a register with the plurality of programmable states (e.g., statelet 110) and a plurality of entries (e.g., 114′, 116′, 118′, 122′, 126′, 128′, 130′, 132′, 138′) having content for a functional operation stored in registers. A portion of the plurality of entries may be compressed, and the remaining portion of the entries may not.

In some embodiments, each of the plurality of rows or columns (e.g., states s0-sn) in the state table 112 corresponding to the monitored states for the software program or process includes (i) one or more transition conditions, (ii) a next state definition, and (iii) an action condition that are used by the statelet 110 to determine and transition from one state to another based on a satisfaction of transition conditions.

Statelet (110). The statelet 110, implemented on a digital logic circuit, is configured, for each instruction cycle of a processing unit (e.g., 106a-106n), to (i) execute a functional operation defined by the plurality of entries (e.g., 114′, 116′, 118′, 122′, 126′, 128′, 130′, 132′, 138′), or a portion thereof, for a given state (e.g., s0, s1, . . . , sn) of a given instruction-level anomaly and (ii) determine and transition to a next state in the state table 112 once a transition condition is met (see Equation Sets 1 and 3). As discussed above, each of the plurality of entries has a pointer/link to a data value in memory or to a register, as shown in the state table 112′.

In some embodiments, the state-machine engine 108, or the statelet 110 thereof, is configured to transition to a next state based on two or more conditions (e.g., IPC and IPC_{Mask}) (see Equation Sets 1 and 3), where each conditions are based on a concatenation of a program counter (PC) and a corresponding CPU instruction (I) (e.g., I+PC=IPC). In some embodiments, the state-machine engine 108, or the statelet 110 thereof, is configured to execute, for a branch CPU instruction, two evaluations of the two or more conditions for transition to the next state (see Equation Sets 1 and 3).

For the statelet 110 to operate as discussed above, the digital circuit for the statelet 110 may include (i) a comparator 118 coupled to a mask register 114 and a value register 116 (shown as Chk Val having a statelet register value 116′), (ii) a down counter circuit 120 coupled to the comparator 118 and a control register 122 (shown as CtrInit having a statelet register value 122′), and (iii) an update action circuit 124 coupled to the down counter circuit 120. In some embodiments, the mask register 114 is configured to (i) receive a CPU instruction from the instruction streams 104, where an instruction may be concatenated with a program counter (e.g., I+PC=IPC), and (ii) mask certain bits of the received instruction or concatenation. In some embodiments, the value register 116 (shown as Chk Val) is configured to provide the comparator 118 with a check value (e.g., baseAddress of a state-machine engine) to be compared against the masked CPU instruction or concatenation. In some embodiments, the comparator 118 is configured to (i) receive the masked CPU instruction or concatenation and the check value, and compare (ii) the masked CPU instruction or concatenation with the check value.

In some embodiments, the down counter circuit 120 is configured with a predefined starting value. When the masked CPU instruction or concatenation and the check value are considered a match by the comparator 118, the down counter circuit 120 is configured to decrement the starting value by 1. In some embodiments, the update action circuit is configured to (i) detect if the starting value is decremented to 0 by the down counter and (ii) pick an entry in the state table 112 for a next state and pick an entry in the action table 134 for an action included in the action signal 136, based on two or more predefined conditions (see Equation Sets 1 and 3).

FIG. 1C shows an example state-machine engine further configured to output the action signal 136 to a template table 140 to conform to a certain format. The templated action signal may then be (i) received by an output stream composer 142, (ii) combined with the instruction streams 104, and (iii) outputted (144) for reporting or displaying purposes.

Multi-Stage-Pipeline Probing Circuit. FIGS. 1D-IF each shows an example multi-stage pipeline implementation of the exemplary system shown in FIGS. 1A-1B. The probing circuit 102 (e.g., 102a-102n) is configured as a multi-stage pipeline (see FIGS. 1D and 3D) that operates in a continuous manner per instruction cycle for a CPU instruction in the CPU instruction streams.

In the examples shown in FIGS. 1D-IF, the multi-stage pipeline implementation can include a (i) a prefetch stage circuit or operation (shown as stages-1 and 0) configured to fetch, in an instruction cycle, a next CPU instruction from a state table 112 of a state-machine engine 108 (e.g., 108a-108n), (ii) a load stage circuit or operation (shown as stage 1) configured to load, in the same instruction cycle or in a next instruction cycle, a plurality of entries (e.g., 114′, 116′, 118′, 122′, 126′, 128′, 130′, 132′, 138′), or a portion thereof, for a given state (e.g., s0, s1, . . . , sn) of a given instruction-level anomaly to the digital circuit for statelet 110 (e.g., by loading the fields (e.g., instruction address, data and register index, etc.) of the next CPU instruction into corresponding registers in the digital logic circuit of the state-machine engine), and (iii) an execute stage circuit or operation (shown as stage 2) configured to execute, in the same instruction cycle or within next two cycles, the digital logic circuit for statelet 110 to execute a functional operation defined by the digital logic circuit and the plurality of entries (e.g., 114′ 116′, 118′, 122′, 126′, 128′, 130′, 132′, 138′), or a portion thereof, for the given state of the given instruction-level anomaly. In some embodiments, each stage in the multi-stage pipeline is split into smaller stages (e.g., stage 1 (e.g., load stage) being split into stages 1a and 1b) to suit the monitoring needs. In some embodiments, any values, functional operations, and/or entries retrieved or executed in a previous stage of the same instruction cycle can be stored in a pipeline register (e.g., 150a, 150b) (e.g., ring buffer coupled to the execute stage circuit or operation) to be used in a subsequent stage in the same instruction cycle. The pipeline register (e.g., 150a, 150b) may be coupled to a direct memory access circuit that is configured to output a data value (e.g., from a previous stage of the same instruction cycle) to a memory controller (e.g., for flash storage).

In some embodiments, the multi-stage pipeline implementation includes a write-back stage or operation (shown as stage 3), subsequent to the execute stage, configured to (i) output an action signal 136 for the given instruction-level anomaly and (ii) write back, in the same instruction cycle, the given state of the instruction-level anomaly and the action value/index chosen for the action signal 136 to the state table 112, the action table 134, and/or the registers in the digital logic circuit for statelet 110 (e.g., value register, control initiation register, etc.), if the current CPU instruction include a write back index or value, denoted as (wbᵢ, whᵥ).

In FIG. 1E, the one or more state-machine engines 108a-108n include duplicates of the state-machine engines that operate in parallel with one another in the same multi-state pipeline implementation. In some embodiments, the one or more state-machine engines 108a-108n include two parallel pairs of i-state machine and d-state machine (e.g., i0-statelet machine and do-statelet machine; i1-statelet machine and d1-statelet machine), and each of the state-machine engines is synchronized with one another. This parallel configuration can address two issues: (i) states in an i-state machine cannot monitor a plurality of events (e.g., caused by CVE) at once, and one or more state machines (e.g., i- and d-state machines) may be incompatible or conflicting with the others and require a separate source. In the parallel configuration, each i-state machine monitors a respective event, and (ii) each state machine (e.g., i- and d-state machine) has its dedicated resources, avoiding conflicts over shared ones.

In some embodiments, the one or more state-machine engines 108a-108n, with the parallel configuration, has 2 pairs of i- and d-state machines per active thread, and a downstream micro-architecture adapted to handle the potential doubling of event rate. The one or more state-machine engines 108a-108n with 2 parallel pairs of i-state and d-state machines can support up to 4 (e.g., 2 i-state machines+2 d-state machines) or 2 coupled (e.g., 2 (i-state machine and d-state machine)) parallel state machines, or any in-between configurations.

In some embodiments, as an active thread is fully sequential, state-machine engines 108 (e.g., i- or d-state machine) (also referred to as monitoring state machines) can be combined into a single large/complex state-machine engine.

In FIG. 1F, the one or more state-machine engines 108a-108n include duplicates of s-statelet and hi-statelet machines in the same multi-state pipeline implementation. Because of the configurations of the s-statelet and hi-statelet machines (see FIGS. 3B-3C), the exemplary system is configured to (i) adapt to various processing units 106 with different thread-switching techniques and (ii) detect system-wide anomalous events.

### Example Methods

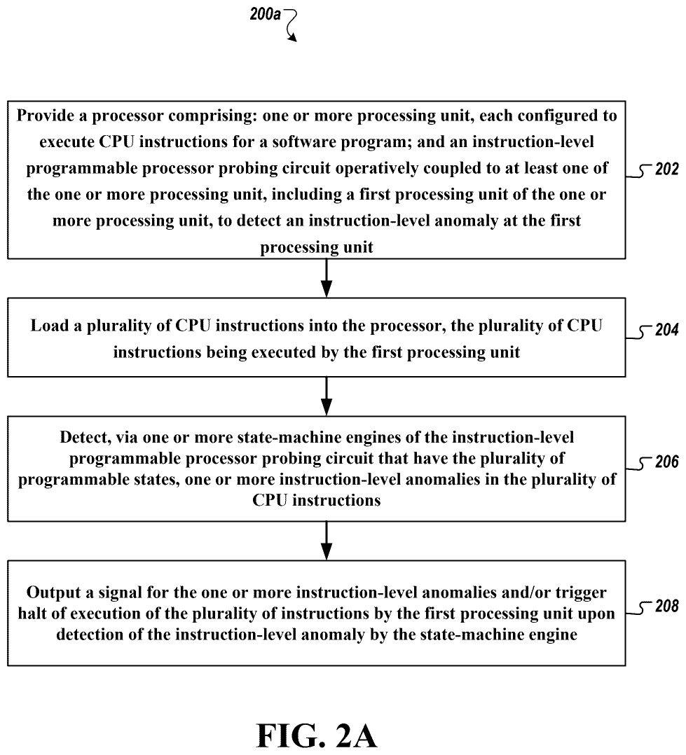

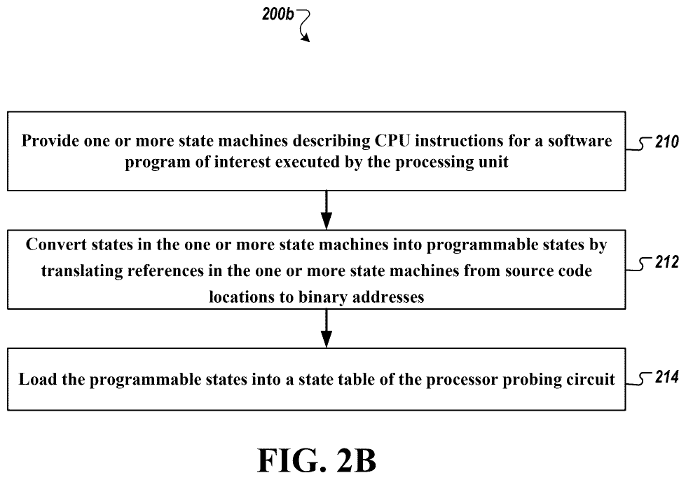

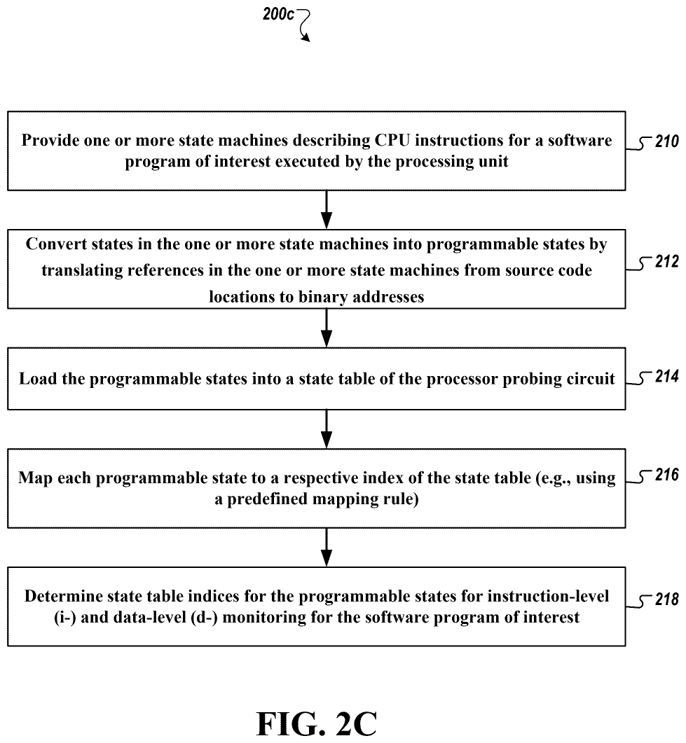

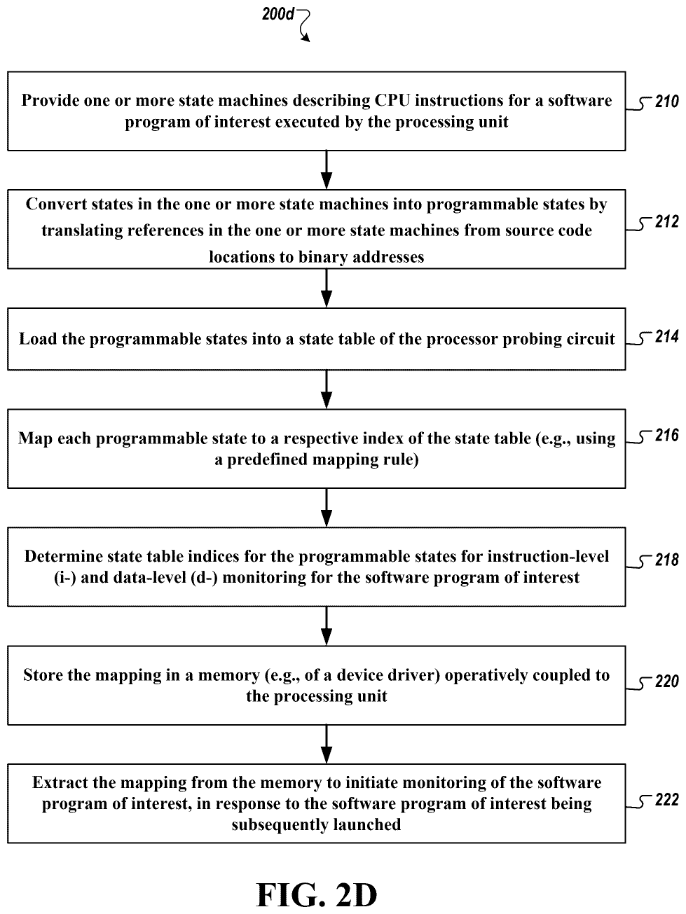

Method of Operation. FIG. 2A shows an example method of operating the exemplary system 200a, in accordance with an illustrative embodiment. The method 200a includes providing (202) a processor (e.g., 101, FIGS. 1A-1B) that includes (i) one or more processing unit (e.g., 106a-106n, FIGS. 1A-1B), each configured to execute CPU instructions (e.g., 104a-104n, FIGS. 1A-1B) for a software program, and (ii) an instruction-level programmable processor probing circuit (e.g., 102a-102n, FIGS. 1A-1B) operatively coupled to at least one of the one or more processing unit, including a first processing unit of the one or more processing units, to detect an instruction-level anomaly at the first processing unit.

In some embodiments, the processor probing circuit (e.g., 102a-102n, FIGS. 1A-1B) includes one or more state-machine engines (e.g., 108a-108n, FIG. 1A) having a plurality of programmable states (e.g., statelet) (e.g., 110, FIG. 1A) to detect the instruction-level anomalies performed by the one or more processing units (e.g., 106, FIGS. 1A-1B). Each state-machine engine includes at least (i) a state table (e.g., 112, FIG. 1A) and (ii) a statelet 110, operating on a digital logic circuit, that employs the contents of the state table (e.g., 112, FIG. 1A).

In some embodiments, the state table (e.g., 112, FIG. 1A) has a plurality of rows or columns corresponding to monitored states for a computer program or process being executed by the first processing unit. The state table (e.g., 112, FIG. 1A) includes a set of states for a number of instruction-level anomalies, where each state includes a plurality of entries having content for a functional operation to be performed by the digital logic circuit. In some embodiments, the digital logic circuit is configured, for each instruction cycle of the first processing unit, to (i) execute a functional operation defined by the plurality of entries, or a portion thereof, for a given state of a given instruction-level anomaly and (ii) determine and transition to a next state in the state table (e.g., 112, FIG. 1A) once a transition condition is met (e.g., each of the plurality of entries comprising a pointer/link to a data value in memory).

The method 200a includes loading (204) a plurality of CPU instructions into the processor (e.g., 101, FIGS. 1A-1B), where the plurality of CPU instructions are executed by the first processing unit. The method 200a includes detecting (206), via the one or more state-machine engines (e.g., 108a-108n, FIG. 1A), one or more instruction-level anomalies in the plurality of instructions. The method 200a includes outputting (208) a signal (e.g., 136, FIGS. 1A-1B) for the one or more instruction-level anomalies and/or trigger halt of execution of the plurality of instructions by the first processing unit upon detection of the one or more instruction-level anomalies by the state-machine engine.

In some embodiments, the one or more state-machine engines (e.g., 108a-108n, FIG. 1A), in the probing circuit (e.g., 102a-102n, FIGS. 1A-1B), include (i) an i-state machine (e.g., i-statelet machine) configured to monitor states of interest in the execution of the monitored program, and (ii) a d-state machine (e.g., d-statelet machine) for monitoring data values involved in the execution of a monitored program. Each of the i-state machine and d-state machine can have a state table (e.g., 112, FIG. 1A) and a digital logic circuit for their corresponding statelets (e.g., 110, FIG. 1A).

In some embodiments, the probing circuit (e.g., 102a-102n, FIGS. 1A-1B) is configured as a multi-stage pipeline (see FIGS. 1D and 3D) that operates in a continuous manner per instruction cycle for a CPU instruction in the CPU instruction streams. The multi-state pipeline can include a (i) a prefetch stage circuit or operation configured to fetch, in an instruction cycle, a next CPU instruction from a state table (e.g., 112, FIG. 1A) of a state-machine engine (e.g., 108a-108n, FIG. 1A), (ii) a load stage circuit or operation configured to load, in the same instruction cycle or in a next instruction cycle, a plurality of entries (e.g., 114′, 116′, 118′, 122′, 126′, 128′, 130′, 132′, 138′, FIG. 1A), or a portion thereof, for a given state of a given instruction-level anomaly to the digital circuit, and (iii) an execute stage circuit or operation configured to execute, in the same instruction cycle or within next two cycles, the digital logic circuit for statelet 110 to execute a functional operation defined by the digital logic circuit and the plurality of entries (e.g., 114′, 116′, 118′, 122′, 126′, 128′, 130′, 132′, 138′, FIG. 1A), or a portion thereof, for the given state of the given instruction-level anomaly. In some embodiments, any values, functional operations, and/or entries retrieved or executed in a previous stage of the same instruction cycle can be stored in a pipeline register (e.g., ring buffer coupled to the execute stage circuit or operation) to be used in a subsequent stage in the same instruction cycle. The pipeline register may be coupled to a direct memory access circuit configured to output a data value (e.g., from a previous stage of the same instruction cycle) to a memory controller (e.g., for flash storage).

In some embodiments, the state-machine engine (e.g., 108a-108n, FIG. 1A), or the statelet thereof, is configured to transition to a next state based on two or more conditions (e.g., IPC and IPC_{Mask}) (see Equation Sets 1 and 3), where each conditions are based on a concatenation of a program counter (PC) and a corresponding CPU instruction (I) (e.g., I+PC=IPC). In some embodiments, the state-machine engine (e.g., 108a-108n, FIG. 1A), or the statelet thereof, is configured to execute, for a branch CPU instruction, two evaluations of the two or more conditions for transition to the next state (see Equation Sets 1 and 3).

In some embodiments, each of the plurality of rows or columns (e.g., state in the state table) corresponding to monitored states for a computer program or process includes one or more transition conditions, a next state definition, and an action condition.

In some embodiments, the one or more state-machine engines (e.g., 108a-108n, FIG. 1A) include at least two state-machine engines, wherein each state-machine engine (e.g., the i-state machine and the d-state machine) is synchronized with one another. At least one of the one or more state-machine engines (e.g., d-state machine) includes a baseAddress register for overflow monitoring.

In some embodiments, the probing circuit (e.g., 102a-102n, FIGS. 1A-1B) is configured to halt CPU operation of the first processing unit within 3-5 instruction cycles of detection of the instruction-level anomaly by the state-machine engine and while the anomaly is being executed by the one or more processing units (e.g., 106a-106n, FIGS. 1A-1B). In some embodiments, a portion of the plurality of entries in the state table (e.g., 112, FIG. 1A) is compressed, while the remaining portion is not.

In some embodiments, the digital logic circuit includes (i) a comparator (e.g., 118, FIG. 1A) coupled to a mask register (e.g., 114, FIG. 1A) and a value register (e.g., 116, FIG. 1A), (ii) a down counter circuit (e.g., 120, FIG. 1A) coupled to the comparator (e.g., 118, FIG. 1A) and a control register (e.g., 122, FIG. 1A), and (iii) an update action circuit (e.g., 124, FIG. 1A) coupled to the down counter circuit (e.g., 120, FIG. 1A) and configured to output a output value to a pointer of an action table (e.g., 134, FIG. 1A).

Method of Programming. FIGS. 2B-2D each shows an example method of programming the exemplary system, and an instruction-level programmable processor probing circuit thereof (e.g., 102, FIGS. 1A-1B), in accordance with an illustrative embodiment.

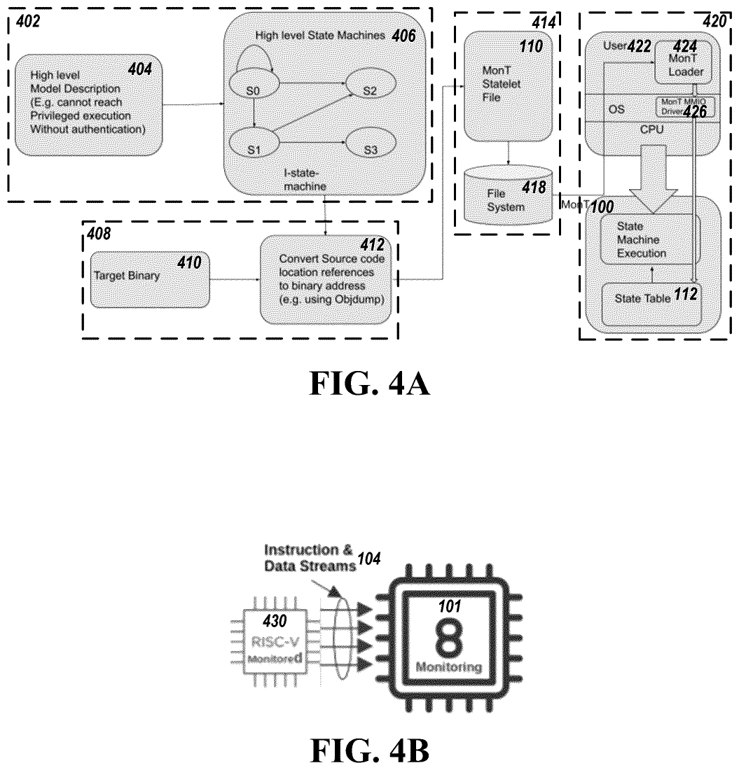

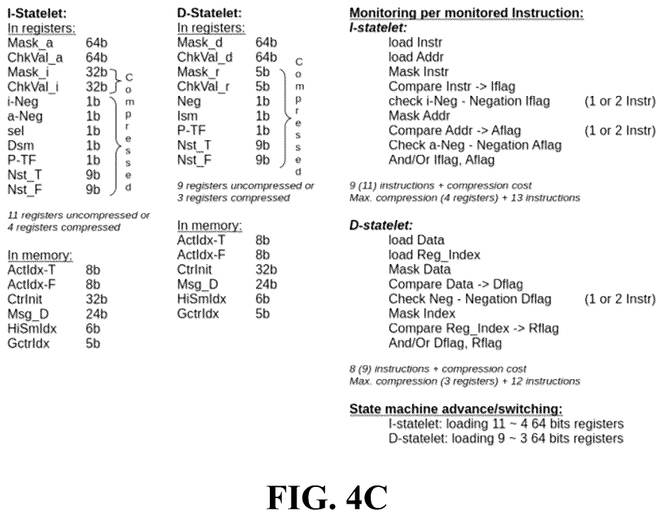

In FIG. 2B, the method 200b includes providing (210) one or more high-level state machines (e.g., 406, FIG. 4A) describing CPU instructions for a software program of interest executed by a processing unit (e.g., 106a-106n, FIGS. 1A-1B). The one or more state machines can include one or more transition conditions, a next state definition, and an action condition.

The method 200b includes converting (212) states in the one or more state machines into programmable states (e.g., 110, FIG. 1A) (e.g., statelets of state-machine engines 108) by translating references in the one or more state machines from source code locations to binary addresses, wherein the programmable states (e.g., 110, FIG. 1A) are linked via the one or more transition conditions.

The method 200b includes loading (214) the programmable states (e.g., 110, FIG. 1A) into a state table (e.g., 112, FIG. 1A) of the processor probing circuit (e.g., 102a-102n, FIGS. 1A 1B). In some embodiments, the state table (e.g., 112, FIG. 1A) has a plurality of rows or columns corresponding to monitored states for the software program of interest. The state table also includes a set of states for a number of instruction-level anomalies, each state having a plurality of entries with content for a functional operation to be performed (e.g., by a digital logic circuit).

In FIG. 2C, in addition to the steps 210-214, the method 200c further includes mapping (216) each programmable state to a respective index of the state table (e.g., 112, FIG. 1A) using a predefined mapping rule. The method 200c includes determining (218) state table indices for the programmable states (e.g., 110, FIG. 1A) for instruction-level (i-) and data-level (d-) monitoring for the software program of interest.

In FIG. 2D, in addition to steps 210-218, the method 200d further includes storing (220) the mapping in a memory (e.g., of a device driver) operatively coupled to the processing unit (e.g., 106a-106n, FIGS. 1A-1B). The method 200d includes extracting (222) the mapping from the memory to initiate monitoring of the software program of interest, when the software program of interest is subsequently launched.

### Example State Machine and Statelet

Monitoring program execution at instruction-level granularity can facilitate real-time detection and prevention of exploits as they progress, before they can achieve a foothold and fully compromise a system.

The exemplary system is configured for online/real-time program execution monitoring at instruction level granularity, at the nominal speed of a main (monitored) processor, without requiring any program/software instrumentation.

FIG. 3A shows an example operational pipeline of the exemplary system that employs state machines 108 and statelets 110. FIG. 3A, subpanel (a) shows how the coprocessing pipeline of the exemplary system can be connected to a Reduced Instruction Set Computer (RISC-V) Rocket pipeline. In some embodiments, the exemplary system is programmed to monitor RISC-V Rocket's program execution, instruction by instruction, without degrading Rocket's performance or speed.

State Machine and Statelet. The exemplary system employs programmable statelets 110 to perform online, instruction-level monitoring. Statelet is a programmable hardware implementation of a time-sliced state machine. Statelet and its program can represent the functionality and behavior of a state within a state machine 108 at a particular clock cycle. A set of statelet operations can represent a state machine 108. As the state (e.g., s0, s1, s2, etc.) within the state-machine 108 advances from one state to another, the statelet program can advance along with it. State machine programmed into statelet(s) can perform pattern/event recognition, and notify a security driver running in the main processor core when suspicious events are detected.

FIG. 3A, subpanels (b) and (c) show a relationship between a state machine (see subpanel (b)) and its manifestation on (programmed) statelets (see subpanel (c)). FIG. 3A, subpanel (d) shows an example state table 112 of the exemplary system configured to store the corresponding statelet's program, where each state table entry can describe an individual state's functionality and behavior.

The exemplary system can be considered a monitoring co-processor with programming abstraction of a state machine. A statelet 110 can be programmed to represent a particular state in a state machine 108 and the transitions from said state to other states. A state machine 108 can be represented as a set of statelets' descriptions/instructions and transition graphs stored in the state table 112 (e.g., program/instruction memory of the exemplary system).

The exemplary system can be thread-aware. A state machine 108 can be initiated to follow a particular thread. Statelets' programs can be switched in with a newly activated or resumed thread, and are swapped out when a thread is suspended or terminated. The exemplary system can employ hardware logic and memory (e.g., thread table) to automatically swap in and out statelets' programs following the operating systems' thread activation, suspension, and termination.

A program for each state, its transitions, and the state-associated action to be performed can be recorded in a state table entry, one state table entry per state. The exemplary system can support a state machine 108 of arbitrary size. However, the size of its internal state table memory limits the number of states it can hold. A driver of the exemplary system may extend this limitation by replenishing the state table 112 of the exemplary system when necessary, which, however infrequent, can add additional load to the monitored processor and hence can introduce performance overhead.

Statelet and state machine programming abstraction can use a linked list to chain together the exemplary system's instructions stored in the state table 112. Each state table entry can also contain a pointer to an entry in an action table prescribing what action(s) and log packet(s) need to be generated upon statelet program exit. The exemplary system can use a linked list to string together its instructions (statelet description). The exemplary system can employ a prefetching logic to anticipate state changes and avoid stall conditions.

The architecture of the exemplary system can be modular and require minimal adaptation to the main/monitored CPU design. The modification to the host/monitored CPU design can be limited to exporting ports for instructions and the corresponding instruction-address streams, a stream of write-back data, and the associated register-file-index.

Hardware designs of the exemplary system and associated statelets 110 can be universal across different processor architectures (ISA). A similar design can be attached to monitor program execution on various architectures, such as RISC-V, ARM & and x86. The statelets' program, however, may be unique for each of the architectures.

The exemplary system can support two different statelets 110: a data monitoring statelet (d-statelet, see FIG. 3C) and an instruction monitoring statelet (i-statelet, see FIG. 3B). In some embodiments, the exemplary system can support a physical memory address monitoring statelet (m-statelet).

In the exemplary system, d-statelet and i-statelet can monitor events within a program thread. Within a thread, events can require coordination between i-statelet & d-statelet. For this purpose, state table entries can be programmed to synchronize (and/or interlock) the operations of i-statelet and d-statelet.

i-Statelet and i-State Machine. States in the i-state machine can correspond to specific “states of interest” in the execution of a monitored program. As the monitored program progresses through different states, so does the i-state-machine.

FIG. 3B shows an example i-statelet, in accordance with an illustrative embodiment. Starting from its initial state, the i-statelets (i-state) can detect events for transition from one state to another based on the instruction (e.g., 310a and 310b) and/or the address (i.e., program counter or PC) of instructions executed by the monitored process. To allow some flexibility in the matching, the specification of both an IP_{Mask} (e.g., 312a and 312b) and an IP (Tal (e.g., 314a and 314b) can be enabled for each state, i.e., the condition for state transition being: IPC&IPC_{Mask}==IPC_{Val} (shown at 316a and 316b), with IPC being a concatenation of PC and the corresponding Instruction, i.e., IPC=cat(Instruction, PC). Finally, to handle the two execution paths taken by a branch instruction, each state (i-statelet) in the i-state-machine can have two possible successor states, each governed by its own set of (IPC_{Mask}, IPC_{Val}) for state transition; the i-state-machine can maintain its state when none of the current state transition conditions are met. The action taken at each state transition, or when no transition occurs, can be programmed by specifying an ‘action index’ 128 (e.g., 128a and 128b) for each condition at each state. In some embodiments, the actions supported in the exemplary system are “do nothing” and “raise exception”. In some embodiments, the exemplary system supports richer and more flexible (programmable) action units.

In summary, a single state (i-statelet) in the i-state machine of the exemplary system can be described by the tuple (IPC_{Mask1}, IPC_{Val1}, NextState₁, Action₁, IPCMask₂, IPC_{Val2}, NextState₂, Action₂, Action_{Nop}), such that if the i-state machine is currently at state st, and the IPC of the monitored program is IPCₜ, its next state Sₜ₊₁ (e.g., 126a and 126b) and the action taken Actionₜ (e.g., 128a and 128b) can be given by Equation Set 1.

$${IPC}_{t} = cat ( {Instruction}_{t} , {PC}_{t} ) \qquad ( Eq . Set 1 )$$

$${s}_{t + 1} = \{ \begin{matrix}{NextState}_{1} , & ( {IPC}_{t} \& {IPC}_{Mask 1} == {IPC}_{Val 1} ) \\ {NextState}_{2} , & ( {IPC}_{t} \& {IPC}_{Mask 2} == {IPC}_{Val 2} ) \\ {s}_{t} , & otherwise\end{matrix}$$

$${Action}_{t} = \{ \begin{matrix}{Action}_{1} , & ( {IPC}_{t} \& {IPC}_{Mask 1} == {IPC}_{Val 1} ) \\ {Action}_{2} , & ( {IPC}_{t} \& {IPC}_{Mask 2} == {IPC}_{Val 2} ) \\ {Action}_{Nop} , & otherwise\end{matrix}$$

d-Statelet and d-State Machine. While the i-state machine supports control-flow-based monitoring of the target process, the d-state machine enables monitoring based on the data values involved in the execution. FIG. 3C shows an example d-statelet, in accordance with an illustrative embodiment.

The d-state machine can monitor which register is written and the value written to it (i.e., the index and value for the “write-back” to the register file) by the current instruction. Since the d-state machine focuses on data value rather than PC value or instruction, the d-state machine can perform state transition checks using relational operators other than equality. Thus, in the d-state machine, the type of operator used for state transition comparison can be specified; in some embodiments, the d-state machine uses equality (=), “greater than or equal to” (≥), and “less than” (<). Specifically, if the write-back index and value are denoted as wbᵢ and wbᵥ, the state transition of the d-statelet can be controlled by Equation 2 (shown as 320), with Op∈{==,≥,<}.

$$( {wb}_{i} \& {Ind}_{M a s k} == {Ind}_{T a r g e t} ) ⋀ Op ( wb , \& {Val}_{M a s k} , Va {l}_{T a r g e t} ) \qquad ( Eq . 2 )$$

Unlike the i-state machine, each state (d-statelet) in the d-state machine is only configured to monitor for one set of conditions, with the next state (e.g., 126a and 126b) and “action” (e.g., 128a and 128b) specified for the case of condition match and condition not match. In summary, if the current state of the d-state machine is s, and the current instruction has write-back index/value (wbᵢ_{ₜ}, wbᵥ_{ₜ}), the next state sₜ₊₁ (e.g., 126a and 126b) and action for the current state Actionₜ (e.g., 128a and 128b) can be given by Equation Set 3.

$${s}_{t + 1} = \{ \begin{matrix}{NextState}_{t , T} , & ( \begin{matrix}{wb}_{{i}_{t}} \& {Ind}_{Mask} == \\ {Ind}_{Target} ⋀ Op ( {wb}_{{v}_{t}} \& {Val}_{Mask} , {Val}_{Target} )\end{matrix} ) \\ {s}_{t} , & otherwise\end{matrix} \qquad ( Eq . Set 3 )$$

$${Action}_{t} = \{ \begin{matrix}{Action}_{t , T} , & ( \begin{matrix}{wb}_{{i}_{t}} \& {Ind}_{Mask} == \\ {Ind}_{Target} ⋀ Op ( {wb}_{{v}_{t}} \& {Val}_{Mask} , {Val}_{Target} )\end{matrix} ) \\ {Action}_{t , F} , & otherwise\end{matrix}$$

s-Statelet and s-State Machine. In some embodiments, the exemplary system is thread-aware. Statelets' programs can be switched in with a newly activated or resumed thread, and swapped out when a thread is suspended or terminated. The exemplary system can employ hardware logic and memory (e.g., s-statelet) to swap in and out statelets' programs following the operating systems' thread activation, suspension, and termination.

FIG. 3D shows an example s-statelet, in accordance with an illustrative embodiment. Different processing units (e.g., CPUs) employ different thread switching techniques, so the s-statelet in FIG. 3D is configured to adapt to various processing units to which the exemplary system is coupled.

hi-Statelet and hi-State Machine. FIG. 3E shows an example hi-statelet, in accordance with an illustrative embodiment. As shown, the hi-statelet is configured to maintain a system-wide statistic (e.g., global counters) and detect system-wide events. Per-thread i-statelet and/or d-statelet state transition can (i) trigger an event for the hi-statelet and (ii) record the event at a particular global-counter.

Synchronizing the d-State Machine and i-State Machine. Hypothetically, standalone d-state machines can be created to perform monitoring of a program's execution, similar to how the i-state machine can be constructed by identifying sequences of critical (wbᵢ, wbᵥ) pairs that signify important states of the monitored process. However, since programs are designed by specifying control flow (e.g., using constructs like if-else and loops), this approach to monitoring is considered unnatural. Nevertheless, monitoring data values is essential for detecting issues such as buffer overflows. To utilize the d-state machine, a synchronization mechanism is developed to match the state transition of the d-state machine with that of the i-state machine. This synchronization can facilitate the i-state machine to target important instructions (e.g., check for a loop's terminating condition involved in a buffer overflow), while the d-state machine can attach checks for the data values involved in the instructions (e.g., the value of the index variable used in the loop containing the overflowing instruction).

States in the d-state machine can be specified as ‘wait states’. For all wait states in the d-state machine, a state transition occurs only if and only if the i-state machine transitions from the current state sₜ to the state sₜ₊₁, with the next state of the d-state machine also being sₜ₊₁, meaning the i- and d-statelets share the same state-table index. Since wait states in the d-state machine do not monitor any condition, the specified action index is ignored, and the output action is “NOP”.

Handling Optimized Buffer Access. The “index” for an overflown buffer may not be saved in any variable. In more optimized cases, the base address of the source and destination buffers may be loaded into registers, and the loop containing the buffer overflow may increment those registers each time to determine where to read from/write to next. In this case, monitoring the write-back values of relevant instructions reveals only the exact accessed address, but it is impossible to determine whether the access is out of bounds without knowing the base address of the array.

In some CVEs, a base address of an overflown buffer is loaded in some instructions. Based on this observation, a base Address register can be added to the d-state machine, and a grabBase flag can be used to indicate whether a state should update this register. Whenever the d-state machine enters a state with grabBase set, the incoming why can be saved to the base Address register, regardless of whether the state is a wait state. When used in combination with the appropriate i-state register, the grabBase-baseAddress configuration enables the base Address to be updated with the current why value until the target instruction that loads the base address of the buffer of interest is reached. At that point, the d-state machine, synchronized with the i-state machine, can switch to a non-grabBase state, leaving the base Address at the value loaded by the target instruction. This base Address can later be used to compare against the target address of the overflowing read/write instruction to determine if the read/write is out of bounds.

### Example Implementation

System Programming. The exemplary system can be programmed to monitor binary programs. Given a binary of interest, with the hardware for executing any i-state and d-state machines, the exemplary system can be used to enforce a model of the behavior of the binary. The model can be either (i) a “positive model”, indicating how benign execution of the binary should behave, or (ii) a “negative model”, describing behavior that indicates the execution is compromised.

A goal of programming the exemplary system 100 is to populate its state table with the i- and d-state machines program/instructions for performing the targeted monitoring. FIG. 4A shows an example operation flow for programming and/or loading the exemplary system, as described in relation to FIGS. 2B-2D. As shown, at step 402, the high-level description of a model 404 can first be converted into a high-level state machine 406, with important states identified and conditions for state transition determined. The state machine 406 still references events and locations in the source code level (e.g., state s₀ represents the execution reaching the beginning of function fin the source).

At step 408, all the references to source code locations, integrated with a target binary 410, should be converted (412) to their corresponding binary addresses before they can be used to build a state-machine engine (e.g., 108, FIGS. 1A-1B) and program statelets 110 of the exemplary system 100, which may populate the state table 112 of the exemplary system 100. In some embodiments, the binary 410 is not stripped, so the conversion 412 can be achieved using simple decompilers, such as Objdump or address2line. For a stripped binary 410, a more sophisticated decompiler may be necessary for the conversion 412. In some embodiments, if any data values referenced in the high-level state machine have the same value during execution (and in the statelets/state table of the exemplary system), then no conversion 412 is needed (i.e., the high-level state machine 406 can be directly used as a state-machine engine 108).

At step 414, with all references to source code locations resolved, individual states (identified in step 402) can be converted to statelets 110 of the exemplary system, which can then be (i) chained together based on state transitions in the high-level state machine 406 and (ii) stored in a file system 418.

At step 420, the statelets 110 can be loaded into the state table 112 of the exemplary system 100. For this purpose, a user space program 422 is configured to read an input file, and a device driver 424 (shown as MonT loader) is configured to load the state table 112 of the exemplary system 100 with the file's content through memory-mapped input/output 426 (MMIO).

In some embodiments, multiple state machines can be packed into the state table 112 (e.g. state machine one starting at index 0, state machine two starting at index 5), and a user can specify, through the device driver 424, the “COMM” name of programs of interest, as well as the index of the initial state of the i- and d-state machines for monitoring each program. Such mapping can be stored in the memory of the device driver 424, which, upon detecting the launch of any program of interest, can communicate with the exemplary system 100 through MMIO 426 to reinitialize the state machines to the specified states and start the monitoring by the exemplary system 100.

The exemplary system can also monitor any write to the thread pointer (tp) register to save and restore the state machines upon context switches.

The driver of the exemplary system can provide utility for loading the state table of the exemplary system. Any user can run this utility to load the state table of the exemplary system, hence controlling the operation of the exemplary system.

Software on a Processor Implementation. In some embodiments, the exemplary system is implemented as software on a processor. FIG. 4B shows an example monitoring processor 101, having the exemplary system implemented thereon, configured to monitor a RISC-V processor 430. Both processors 101 and 430 have 64-bit architecture and may or may not have the same instruction set architecture (ISA). Streams of instruction 104 (e.g., 32 bits) and their addresses (e.g., 64 bits), and writeback data (e.g., 64 bits) and their register index (e.g., 5 bits) can be piped from the monitored processor 430 to the monitoring processor 101, at every clock cycle of the monitored processor. The instruction and data streams 104 can be loaded into First-In-First-Out (FIFO) queues for the monitoring processor to process sequentially.

The states of the exemplary system can be associated with a set of actions that may be triggered when the state is reached. The monitoring kernel (on the processor 101) of state machine operation per monitored data may require between 17 (or 20) instructions when utilizing 18 registers to hold state machine parameters or 42 (or 45) instructions, then state machine parameters are compressed into 7 registers. Some architectures (e.g., x86 64) may have 8 general-purpose registers and incur additional de-compression cost of 25 instructions for every monitored instruction to the total cost of 42 (or 45) instructions.

FIG. 4C shows the state machine parameters for instruction monitoring (i-statelet), data monitoring (d-statelet), and the pseudocodes for the instruction and data monitoring, if implemented as software on a CPU. The negation operation is conditional upon a flag, so it requires 1 instruction (checking the flag) if the flag is not set or two instructions when the flag is set (e.g., the i-statelet requires 9 cycles if none of the flags are set, 10 cycles if one of the flags is set, or 11 cycles when both flags are set). When the state machine (e.g., 108, FIGS. 1A-1B) switches, non-compressed parameters may require loading 20 registers, while compressed parameters may require loading 7 registers.

In FIG. 4C, the pseudocodes and register assignment listing are used to calculate how many cycles are needed to implement minimum i-statelet & d-statelet functionality on a general-purpose CPU (e.g., RISC-V, MIPS, PowerPC, ARM, etc).

### Example Enforcement of Expected Behavior

In some embodiments, the exemplary system can be programmed to enforce a program execution model and detect any deviation from the expected behavior of the target program. In particular, many programs can contain security-sensitive variables that should be defined and used properly, or the program may start to exhibit behavior harmful to the system as a whole. For example, if the variables that control the security protocol are corrupted, the program can protect its network traffic with outdated crypto. Similarly, authentication/access control-related variables can be tampered with to implement privilege escalation attacks.

The expected behavior regarding how these variables should be defined and used can be expressed as two kinds of invariant properties, e.g., “if variable s is set to value k at instruction I_{d}, its value should also be k when it is used at instruction Iᵤ”, or “privileged instruction at Iₚ should not be executed without executing instruction Iₐ that grant the current process the privilege.” Similar value invariant properties have been enforced in [20]. The protection provided by enforcing the invariant properties may be attack-agnostic. The sensitive variables can be corrupted by any buffer overflow, use-after-free, or hardware bugs like Rowhammer [17], and the manifestation of such corruption may be detected to stop any attack.

With the exemplary system, enforcing the first kind of invariant property with a d-state machine is possible, targeting (i) the instruction that loads the value to be written at I_{d} and (ii) the value of s loaded at Iᵤ. The exemplary system can also enforce the second kind of invariant property using an i-state machine alone.

In some embodiments, the exemplary system is used to enforce (i) the first kind of invariant property to protect a file transfer protocol daemon (ftpd) server (e.g., Washington University ftpd (wuftpd) server) against non-control data attacks that lead to privilege escalation, and (ii) the second kind of invariant property to protect a sudo-like program (referred to as tinysudo) against privilege escalation through overwriting a global variable that records whether the current user has been authenticated.

Server (e.g., ftpd) Protection. The non-control data attack against the wuftpd server [8] is detailed as follows: the wuftpd server maintains the current user's universal identification (UID) in a global variable pw->pw_uid to return the server to the user's privilege level after each call to seteuid(0) that temporarily grants the process root privilege. By corrupting pw->pw_uid and setting it to 0, the attacker can achieve privilege escalation and keep the target ftp server at the root level.

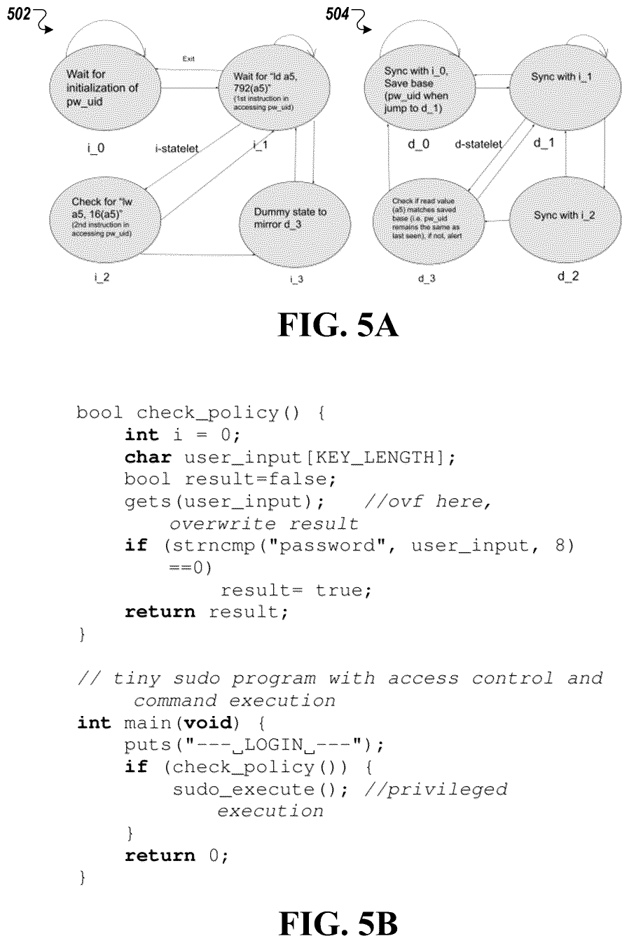

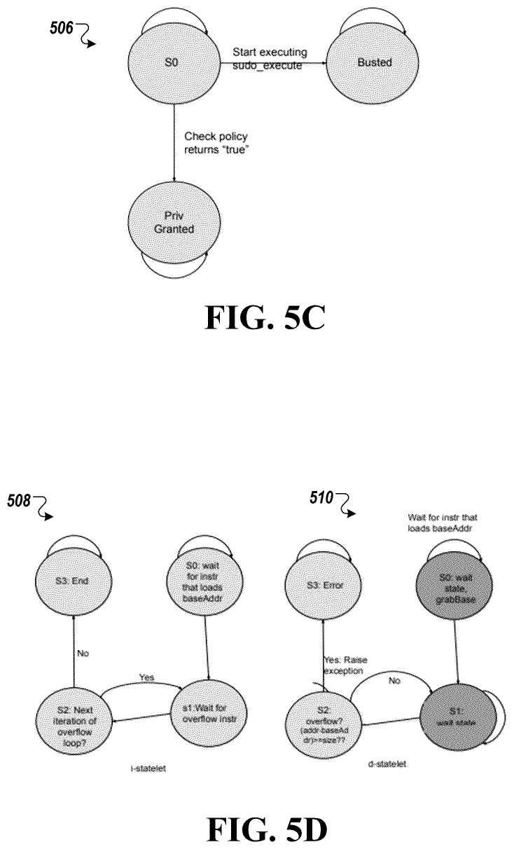

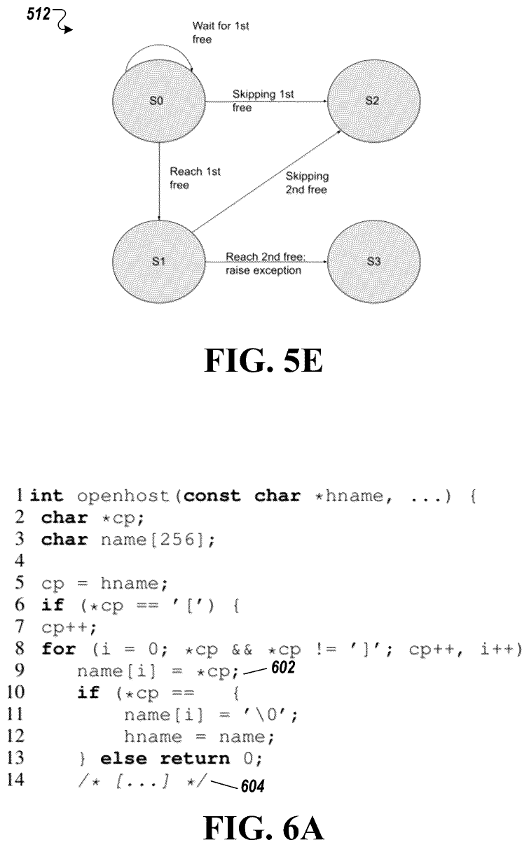

FIG. 5A shows example i-state machine 502 and d-state machine 504 for enforcing proper authentication in a program (e.g., wuftpd), which can detect the corruption of the pw->pw_uid variable. Creating the state machines 502 and 504 can start with analyzing the source and disassembled binary code of the wuftpd server to identify: (i) the address of the code that initializes pw->pw_uid for each user session, and (ii) the instruction sequence used to access pw->pw_uid (which is “ld a5, 792(a5); lw a5, 16(a5); mov a0, a5;”). After that, the state machines 502 and 504 can be devised to enforce the following high-level policy: the state machines 502 and 504 can save the initial value of pw->pw_uid in the baseAddress register of the d-state machine, and alert when subsequent read (indicated by the instruction sequence “ld a5, 792(a5); lw a5, 16(a5); mv a0, a5;”) yields a different value for pw->pw_uid.

Specifically, the state machines 502 and 504 can operate as follows. State i₀ in the i-state machine 502 waits for the instruction for initializing pw->pw_uid to be executed, and jumps to i₁ after that instruction. In the meantime, state d₀ of the d-state machine 504 is a “wait state” and can be in sync with the i-state machine 502 so that the initial value of pw->pw_uid can be saved in the baseAddress register before both state machines 502 and 504 jump to the next state, i₁ and d₁, respectively, after the execution of the instruction for initializing pw->pw_uid. States i₁ and i₂ of the i-state machine 502 detect the instruction sequence “ld a5, 792(a5); lw a5, 16(a5)” and jump to i₃ upon detecting this sequence. States d₁ and d₂ are both wait states in sync with i₁ and i₂, respectively, so when the i-state machine 502 jumps to i₃, the d-state machine 504 can jump to d₃, where it checks the pw->pw_uid value loaded into as against the base Address register and alerts when the two differ. While the state machines 502 and 504 may not check for the last instruction “mov a0,a5,” an analysis of the disassembly of the wuftpd binary shows it may not cause any false positives: the value in register a₅ is always used in the instruction that follows “Id a5, 792(a5); lw a5, 16(a5)”. State i₁ also checks for the execution of instructions that signify the end of the current user session and returns to i₀ for the next session.

Program (e.g., tinysudo) Protection. FIG. 5B shows a sudo-like program with a buffer overflow vulnerability that allows an attacker to execute the function sudo_execute without providing the correct password. In particular, gets in check_policy function can overflow the user_input buffer and overwrite result to make check_policy return true without match_key receiving the right password, thus resulting in the execution of sudo_execute.

This privilege escalation in tinysudo can be stopped by enforcing the proper execution of the authentication process to ensure that the execution does not reach sudo_execute without first reaching the return true line in match_key. This high-level authentication policy, after step 402 in FIG. 4A, can be expressed as a state machine (see FIG. 5C). FIG. 5C shows an example i-state machine 506 for enforcing proper authentication in a program (e.g., tinysudo). The remaining part of the workflow in FIG. 4A can then be used to turn the state machine 506 into a format that can be loaded into the state table (e.g., 112) of the exemplary system.

### Example CVE Detection

The exemplary system can detect exploitation of known instances of buffer overflow and use-after-free (UAF). The exemplary system can be a low-cost, non-intrusive, post-deployment solution to stop the exploitation of newly identified vulnerabilities promptly, usually before the exploit corrupts the binary's state in an irreversible manner.

Buffer Overflow. FIG. 5D shows example i-state machine 508 and d-state machine 510 for detecting buffer overflow. As shown, the state machines assume the targeted buffer overflow can be described by the following high-level states: (i) an instruction that loads the base address of the buffer that can be overflown, and (ii) an instruction that load the address for the out of bound read/write that leads to the buffer overflow, and (iii) an exit of the loop that contains (ii).

Thus, the state machines 508 and 510 can operate as follows. Since states s₀ and s₁ in the d-state machine 510 are “wait states”, the d-state machine 510 may only leave these states when the i-state machine 508 transitions away from its s₀ and s₁, with the next state of the d-state machine 510 the same as the i-state machine 508's next state (i.e., the state machines 508 and 510 may have the same state index after the transition). This allows the i-state machine 508 to guide both state machines 508 and 510 through the execution of the instruction that loads the base address of the potentially overflowable buffer, so the d-state machine 510 can perform the correct bound check when the instruction responsible for loading the address for the out-of-bound read/write that leads to the buffer overflow is executed.

In particular, both state machines 508 and 510 may remain in s₀ until the instruction that loads the base address of the target buffer is executed. As a result, this value may be saved in the base Address register when the state is transitioned to s₁. Both state machines 508 and 510 may stay in s₁ until the overflowing instruction, so that in s₂, the d-state machine 510 can check for buffer overflow. The i-state machine 508 may return to s₁ at the beginning of the next iteration, or s3 if the control exits the loop, while the d-state machine 510 may go back to s₁ if there is no overflow; otherwise, the d-state machine 510 may go to s₃.

Use-After-Free (UAF). In some embodiments, only an i-state machine is needed to detect the exploitation of a use-after-free or double-free vulnerability. The high-level states involved are: (i) the initial state (s₀), (ii) the free state (s₁), (iii) the use/second free state (s₃), and (iv) a safe state that indicates (ii) or (iii) cannot be reached (s₂).

FIG. 5E shows an example i-state machine 512 for detecting a double-free (DF) exploit. The i-state machine 512 assumes the free and the use (or second free) instruction either (i) must alias if they are executed in the same invocation of the containing function, or ii) may eventually alias. If the two may or may not alias, the exemplary system cannot detect the exploitation of the UAF/DF without the chance of false positives.

### Experimental Results and Additional Examples

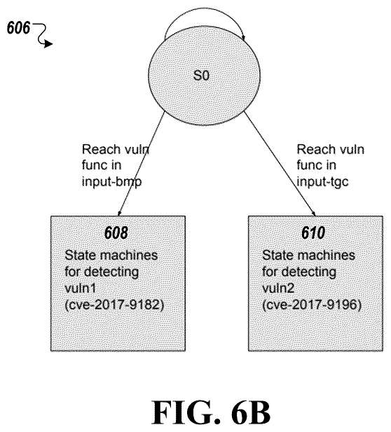

A study was conducted to develop and evaluate an experimental system (also referred to as “MonT”) comprising one or more instruction-level programmable processor probing circuits (e.g., 102a-102n, FIGS. 1A-1B), each configured to detect anomalies in CPU instruction streams (e.g., 104a-104n, FIGS. 1A-1B) for a software program that are executed by the one or more processing units (e.g., 106a-106n, FIGS. 1A-1B), as described in relation to FIGS. 1-2. The study used the experimental system to detect real-world CVEs. FIG. 6A shows an algorithm of a real-world CVE, e.g., CVE-2018-12323, that was detected by the experimental system.

Referring to FIG. 6A and FIG. 5D, s₀ targets the binary instruction which loads the base address of array name the first time line 602 is executed, s₁ waits for the control flow to reach future iterations of line 602, so both i- and d-state machines can be at s₂ when the address computation of name [i] in line 602 is executed; as such, the d-state machine can perform the bound check &name [i]—baseAddress<256 at s₂ and alert if there is an overflow. Finally, s₃ refers to line 604, the exit of the loop that contains the out-of-bound access (line 602).

Identifying the source code location corresponding to each state in the high-level state machine was only the first step. Subsequent steps included using Objdump/addr2line to map these locations to binary addresses, creating the actual statelets forming the state machine, and finally using the utility program to load all statelets into the state table of the experimental system and initiate the experimental system to start monitoring.

The state machine for detecting the CVE-2018-12327 could be simplified if the value of variable i was monitored to ensure it was less than 256. However, not all CVEs have the current index in the array accessed in an explicit variable. The state machine template in FIG. 5D was chosen for CVE-2018-12327 because it was a solution that makes the least assumption about vulnerable code.

Table 1 shows the real-world CVEs detected by the experimental system.

TABLE 1

| CVE | Program | Type |
|---|---|---|
| CVE-2004-1257 [2] | abc2mtex | overflow |
| CVE-2004-1279 [21] | jpegtoavi | overflow |
| CVE-2017-16353 [15] | GraphicsMagick | overflow |
| CVE-2018-12327 [24] | ntpq | overflow |
| CVE-2020-14931 [13] | dmitry | overflow |
| CVE-2017-11403 [16] | GraphicsMagick | use-after-free |
| CVE-2017-12858 [23] | libzip | use-after-free |
| CVE-2017-9182 [5] | autotrace | use-after-free |
| CVE-2018-20623 [29] | readelf | use-after-free |
| CVE-2017-9186 [4] | autotrace | integer overflow |
| CVE-2017-9196 [28] | | integer overflow |

In the study, experimenting with each of these CVEs involved (i) compiling the vulnerable code in RISC-V, (ii) applying the workflow in FIG. 4A to build the state machines of the experimental system and populate the state table of the experimental system, (iii) running the binary from (i) with Proof of Concept (PoC) to trigger the targeted vulnerability, and (iv) observing if the experimental system terminated the program before the program was crashed by the PoC. At the end of the experiment, the state machines of the experimental system successfully detected exploitation of the target vulnerabilities before the exploitation was successfully performed.

Detection Latency. The experimental system could detect exploitation of known vulnerabilities when the exploitation was still in progress. In contrast, current systems, such as CFI [1] or those based on Intel PT [19], can only detect the manifestation of successful exploitation of the target vulnerabilities. Early detection by the experimental system can provide a better chance to recover from the attack and continue with normal execution.

The state machines (of the experimental system) for detecting buffer overflow targeted the address computation of the overflowing instruction, and thus could detect the attack before the out-of-bound read/write happened. For CVEs involving libc functions (e.g., memcpy), there may be multiple overflowing instructions, either for handling buffers of different alignment or because of loop unrolling for performance. However, since the study did not have multiple PoC inputs to trigger the overflow of all these instructions, the study configured the state machines to handle the instructions targeted by the PoC. Thus, there may be some delay in detecting other exploitation of the same vulnerabilities involving libc. However, this was only a limitation of the study, not an inherent limit of the experimental system.

For UAF and DF, the state machines (of the experimental system) could detect them when the pointer to the freed object was accessed (used/freed again). In some cases, the study could construct state machines to detect the beginning of the basic block that contained the targeted use/free, thus allowing the detection before the problematic use/free happened. Another approach to avoid the adverse effect of UAF/DF was to delay the actual deallocation of the objects involved. In particular, the state machines (of the experimental system) could be used to both identify free instructions involved in known UAF/DF and also when execution has gone past the use/second free involved, thus confirming the vulnerability was not going to be triggered. The first event could inform the underlying system to delay the actual deallocation, while the second event could allow the underlying system to free the memory involved. Similar approaches were developed in [35], [36], but these studies did not have the means to know when it was time to free up the delay-freed memory and tended to save freed objects for too long.

Implementation on RISC-V. During the synthesis of the study, the AXI bus was the limiting factor. The study did not spend time optimizing the synthesis for higher clock frequency, beyond 100 MHz. By employing frequency scaling, RISC-V & the experimental system could operate at a much higher clock frequency, such as 500 MHz or higher, while the AXI bus operated at 100 MHz.

Hardware Overhead. To measure the hardware overhead incurred by the experimental system (both the part for executing the state machines and for the MMIO with the system on chip (SoC)), the study collected Configurable Logic Blocks (CLBs) utilized for various purposes when synthesizing the PoC SoC with and without the experimental system. Table 2 shows the number of CLBs utilized when synthesizing with and without the experimental system (MonT).

TABLE 2

| Component | Baseline (without MonT) | with MonT | % increase |
|---|---|---|---|
| LUTs | 130469 | 133646 | 2.4 |
| LUT as Logic | 123942 | 130119 | 5 |
| LUT as Memory | 6527 | 6527 | 0 |
| Registers | 177975 | 183557 | 3.1 |
| 8-bit carry | 1112 | 1151 | 3.5 |
| MUX | 15333 | 15390 | 3.7 |

In Table 2, the implementation of the experimental system incurred less than 5% increase in CLB used, and the increase was even among the various categories. Table 3 shows the on-chip power consumption when synthesizing the SoC with and without the experimental system (MonT).

TABLE 3

| Component | Baseline (without MonT) | with MonT | % increase |
|---|---|---|---|
| Dynamic | 4.988 W | 5.228 W | 4.8 |
| Static | 2.609 W | 2.606 W | −0.11 |
| Hard IP | 0.134 W | 0.134 W | 0 |

In Table 3, the experimental system increased the dynamic component by less than 5% and had a negligible impact on the other components. The study also synthesized the experimental system with two parallel pairs of i-statelet & d-statelet (referred to as parallel or FullMonT configuration) (see FIG. 1E) on an FPGA.

Experimental Parallel Configuration. While the experimental system was effective in detecting known vulnerabilities, the experimental system could not handle zero-day vulnerabilities. Furthermore, manual effort was needed to analyze each CVE before the study could program the experimental system to detect said exploits.

To overcome this shortcoming, the study developed an experimental parallel configuration of state machines that facilitated the experimental system to detect the exploitation of all instances of vulnerabilities in a Common Weakness Enumeration (CWE) class, without prior knowledge of the exploit. The parallel configuration (see FIG. 1E) was demonstrated for a stack overflow detection.

To detect stack overflow, a shadow stack of all the locations of the return addresses on the stack (instead of their content) should be maintained, and any store instructions that overwrite any of such addresses should be detected. In particular, the shadow stack could be maintained by detecting (i) any writes to the stack pointer sp (d-state machine), (ii) storing of the ra register (sd ra, x(sp)) (i-state machine), and (iii) loading of the ra register (ld ra, x(sp)) (i-state machine). Then, the overwriting of any return could be detected by (i) checking if the write-back value of any instruction is in the shadow stack, and if so, the register involved is tainted (d-state machine), and (ii) detecting store instructions that use a tainted register as base register (i.e., of the form sd/l/h rx, 0(ry), with ry being tainted) (i-state machine).

The experimental system, with the parallel configuration, included two sets of i- and d-state machines in parallel and a new “storage module” to which state machines could send commands for long-term storage and lookup on this storage.

The “storage module” could be configured to maintain a last-in-first-out (LIFO) queue of stack addresses, and execute the following commands: (i) update saved stack pointer (SP) value, (ii) push (SP+offset) onto LIFO queue, (iii) pop LIFO queue, (iv) check if incoming register value is in LIFO queue, if so, record the incoming register index as tainted, and (v) check if an input register index is tainted, if so alert. The “storage module” could be further configured to support more commands and provide general storage with add, delete, and lookup capability, instead of just LIFO. The experimental system could also have a device interface, so that processing units (e.g., accelerated or specialised processing units) could be coupled to the experimental system and be controlled via the device interface. Indeed, the experimental system was a processor architecture, with programming abstraction of a state machine.

The study implemented a proof of concept for a CWE (stack overflow) detection by employing the experimental system, with the parallel configuration, and attaching a LIFO to its pipeline. The experimental system stopped CVE-2004-1257 and CVE-2004-1279 on Verilator simulation.

Experimental State Machine Chaining. The experimental system could handle multiple CVEs in a same program by combining the state machines for detecting each of these CVEs. For example, autotrace was affected by both CVE-2017-9182 and CVE-2017-9196, the two vulnerabilities found in two different functions. Since any instance of autotrace could only execute one of the two functions, the state machines for the individual CVEs could be combined to detect the exploitation of both underlying CVEs. FIG. 6B shows a state machine 606 for detecting CVE-2017-9182 and CVE-2017-9196 by combining the state machines 606 and 608 for detecting each CVE individually. Both the i- and d-state machines had the same structure, with s₀ being a wait state in the d-state machine.

A combination of state machines (see FIG. 6B) is possible if the states in the two machines never execute in parallel. Instead, either the code targeted by one state machine may execute after the code targeted by the other has finished, or only one set of code can be executed in each instantiation of the vulnerable program.

### Discussion

A design choice in building a system security monitor is to choose which events to monitor. Although high-level events (e.g., system calls) can be monitored at a low performance cost, security systems based on high-level monitoring are easy to evade [32]. Such events can reflect the manifestation of successful attacks (e.g., foreign system calls), but not the root cause of the attacks (e.g., a buffer overflow causing control hijacking). While instruction-level monitoring can, in theory, detect many types of attack when they are still in progress, monitoring events at such granularity presents challenges in practice. Software approach for monitoring such events may require either instrumentation of the target program [1] or running it on a debugger/emulator (e.g., DynamoRIO [6], PIN [18], QEMU [27]), both of which are difficult to deploy in a production environment. Furthermore, software analysis on instruction and data streams may require at least 17 monitoring instructions for every single instruction monitored for an architecture with many general-purpose registers (e.g., many RISC architectures). For architectures with a limited number of general-purpose registers (e.g., x86 64), the same process can take 42 monitoring instructions. In other words, a software implementation of instruction-level monitoring can incur at least 17× (or 42×) performance overhead, not counting instructions for fetching and loading state parameters into the monitoring CPU's registers, which can occur when the monitoring state machine transitions into a new state. Also not included are the instructions for advancing counters and instructions for performing action tasks, which occur along with select state transitions. The monitoring state machine needs to examine every monitored instruction to recognize events of interest, which may lead to monitoring action/state transition/update, since uninteresting events still need to be decoded and recognized before they are discarded. The need to examine every single instruction executed by the main (monitored) CPU leads to the situation in which at least a 17 GHz processor is required for monitoring a 1 GHz processor of the same type. To avoid such prohibitive costs, most systems for monitoring at instruction granularity pre-select a small set of instructions to monitor. For example, in control flow integrity [1], only indirect control transfer instructions are monitored, while in Intel PT [19] (IPT), only instructions that change control flow non-deterministically are monitored. This once again limits the system's capability only to detect the manifestation of a limited class of attacks.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST

[1] Martin Abadi, Mihai Budiu, Ulfar Erlingsson, and Jay Ligatti. Control-flow integrity. In Proceedings of the 12th ACM Conference on Computer and Communications Security, CCS '05, page 340-353, New York, NY, USA, 2005. Association for Computing Machinery.
[2] Cve-2004-1257 detail. https://nvd.nist.gov/vuln/detail/CVE-2004-1257. [Online; accessed 15 Oct. 2024].
[3] AMD. Amd virtex ultrascale+ fpga vcu118 evaluation kit. https://www.xilinx.com/products/boards-and-kits/vcu118.html. [Online; accessed 28 Aug. 2024].
[4] Cve-2017-9186 detail. https://nvd.nist.gov/vuln/detail/CVE-2017-9186. [Online; accessed 15 Oct. 2024]. [5] Cve-2017-9182 detail. https://nvd.nist.gov/vuln/detail/CVE-2017-9182. [Online; accessed 15 Oct. 2024].
[5] Cve-2017-9182 detail. https://nvd.nist.gov/vuln/detail/CVE-2017-9182. [Online; accessed 15 Oct. 2024].
[6] Derek L. Bruening and Saman Amarasinghe. Efficient, transparent, and comprehensive runtime code manipulation. PhD thesis, USA, 2004. AAI0807735.
[7] Sadullah Canakci, Leila Delshadtehrani, Boyou Zhou, Ajay Joshi, and Manuel Egele. Efficient context-sensitive cfi enforcement through a hardware monitor. In Clementine Maurice, Leyla Bilge, Gianluca Stringhini, and Nuno Neves, editors, Detection of Intrusions and Malware, and Vulnerability Assessment, pages 259-279, Cham, 2020. Springer International Publishing.
[8] Shuo Chen, Jun Xu, Emre C. Sezer, Prachi Gauriar, and Ravishankar K. Iyer. Non-control-data attacks are realistic threats. In Proceedings of the 14th Conference on USENIX Security Symposium—Volume 14, SSYM '05, page 12, USA, 2005. USENIX Association.

[9] Garett Cunningham, Harsha Chenji, David Juedes, and Avinash Karanth. d-guard: Thwarting denial-of-service attacks via hardware monitoring of information flow using language semantics in embedded systems. In Proceedings of the 29th Asia and South Pacific Design Automation Conference, ASPDAC '24, page 939-944. IEEE Press, 2024.
[10] Leila Delshadtehrani, Sadullah Canakci, William Blair, Manuel Egele, and Ajay Joshi. Flexfilt: Towards flexible instruction filtering for security. In Proceedings of the 37th Annual Computer Security Applications Conference, ACSAC '21, page 646-659, New York, NY, USA, 2021. Association for Computing Machinery.
[11] Leila Delshadtehrani, Sadullah Canakci, Boyou Zhou, Schuyler Eldridge, Ajay Joshi, and Manuel Egele. PHMon: A programmable hardware monitor and its security use cases. In 29th USENIX Security Symposium (USENIX Security 20), pages 807-824. USENIX Association, August 2020.
[12] Udit Dhawan, Catalin Hritcu, Raphael Rubin, Nikos Vasilakis, Silviu Chiricescu, Jonathan M. Smith, Thomas F. Knight, Benjamin C. Pierce, and Andre DeHon. Architectural support for software-defined metadata processing. SIGARCH Comput. Archit. News, 43(1): 487-502, March 2015.
[13] Cve-2020-14931 detail. https://nvd.nist.gov/vuln/detail/CVE-2020-14931. [Online; accessed 15 Oct. 2024].
[14] Lang Feng, Jiayi Huang, Luyi Li, Haochen Zhang, and Zhongfeng Wang. Rvdfi: A risc-v architecture with security enforcement by high-performance complete data-flow integrity. IEEE Transactions on Computers, 71(10): 2499-2512, 2022.
[15] Graphicsmagick—memory disclosure/heap overflow. https://www.exploit-db.com/exploits/43111. [Online; accessed 15 Oct. 2024].
[16] Cve-2017-11403 detail. https://nvd.nist.gov/vuln/detail/CVE-2017-11403. [Online; accessed 15 Oct. 2024].
[17] Daniel Gruss, Clementine Maurice, and Stefan Mangard. Rowham—‘mer.js: A remote software-induced fault attack in javascript. In Proceedings of the 13th International Conference on Detection of Intrusions and Malware, and Vulnerability Assessment-Volume 9721, DIMVA 2016, page 300-321, Berlin, Heidelberg, 2016. Springer Verlag.
[18] Pin—a dynamic binary instrumentation tool. https://www.intel.com/content/www/us/en/developer/articles/tool/pin-a-dynamic-binary-instrumentation-tool.html. [Online; accessed 15 Oct. 2024].
[19] Intel processor tracing. https://fuchsia.googlesource.com/fuchsia/+/8023e94b8b78/garnet/bin/insntrace/README.md. [Online; accessed 15 Oct. 2024].
[20] Mohannad Ismail, Jinwoo Yom, Christopher Jelesnianski, Yeongjin Jang, and Changwoo Min. Vip: Safeguard value invariant property for thwarting critical memory corruption attacks. In Proceedings of the 2021 ACM SIGSAC Conference on Computer and Communications Security, CCS ‘21, page 1612-1626, New York, NY, USA, 2021. Association for Computing Machinery.
[21] Cve-2004-1279 detail. https://nvd.nist.gov/vuln/detail/CVE-2004-1279. [Online; accessed 15 Oct. 2024].
[22] Sungkeun Kim, Farabi Mahmud, Jiayi Huang, Pritam Majumder, Chia-Che Tsai, Abdullah Muzahid, and Eun Jung Kim. Whistle: Cpu abstractions for hardware and software memory safety invariants. IEEE Transactions on Computers, 72(3): 811-825, 2023.
[23] Cve-2017-12858 detail. https://nvd.nist.gov/vuln/detail/CVE-2017-12858. [Online; accessed 15 Oct. 2024].
[24] ntp 4.2.8p11—local buffer overflow (poc). https://www.exploit-db.com/exploits/44909. [Online; accessed 15 Oct. 2024].
[25] ntpq—standard ntp query program. https://www.ntp.org/documentation/4.2.8-series/ntpq/. [Online; accessed 20 Jan. 2025].
[26] Emanuele Parisi, Alberto Musa, Simone Manoni, Maicol Ciani, Davide Rossi, Francesco Barchi, Andrea Bartolini, and Andrea Acquaviva. Titancfi: Toward enforcing control-flow integrity in the root-of-trust. In 2024 Design, Automation & Test in Europe Conference & Exhibition (DATE), pages 1-6, 2024.
[27] Qemu a generic and open source machine emulator and virtualizer. https://www.qemu.org/. [Online; accessed 15 Oct. 2024].
[28] Cve-2017-9196 detail. https://nvd.nist.gov/vuln/detail/CVE-2017-9196. [Online; accessed 15 Oct. 2024].
[29] Cve-2018-20623 detail. https://nvd.nist.gov/vuln/detail/CVE-2018-20632. [Online; accessed 15 Oct. 2024].
[30] Rasool Sharifi and Ashish Venkat. Chex86: Context-sensitive enforcement of memory safety via microcode-enabled capabilities. In 2020 ACM/IEEE 47th Annual International Symposium on Computer Architecture (ISCA), pages 762-775, 2020.
[31] Christoph Spang, Florian Meisel, and Andreas Koch. Rt-life: Portable risc-v interface for real-time lightweight security enforcement. In Alex Orailoglu, Matthias Jung, and Marc Reichenbach, editors, Embedded Computer Systems: Architectures, Modeling, and Simulation, pages 179-194, Cham, 2022. Springer International Publishing.
[32] David Wagner and Paolo Soto. Mimicry attacks on host-based intrusion detection systems. In Proceedings of the 9th ACM Conference on Computer and Communications Security, CCS '02, page 255-264, New York, NY, USA, 2002. Association for Computing Machinery.
[33] Xinrui Wang, Lang Feng, and Zhongfeng Wang. Promise: A high-performance programmable hardware monitor for high security enforcement of software execution. IEEE Transactions on Computer-Aided Design of Integrated Circuits and Systems, 42(11): 3599-3612, 2023.
[34] Yu Wang, Jinting Wu, Haodong Zheng, Zhenyu Ning, Boyuan He, and Fengwei Zhang. Raft: Hardware-assisted dynamic information flow tracking for runtime protection on risc-v. In Proceedings of the 26th International Symposium on Research in Attacks, Intrusions and Defenses, RAID '23, page 595-608, New York, NY, USA, 2023. Association for Computing Machinery.
[35] Brian Wickman, Hong Hu, Insu Yun, DaeHee Jang, JungWon Lim, Sanidhya Kashyap, and Taesoo Kim. Preventing Use-After-Free attacks with fast forward allocation. In 30th USENIX Security Symposium (USENIX Security 21), pages 2453-2470. USENIX Association, August 2021.
[36] Carter Yagemann, Simon P. Chung, Brendan Saltaformaggio, and Wenke Lee. PUMM: Preventing Use-After-Free using execution unit partitioning. In 32nd USENIX Security Symposium (USENIX Security 23), pages 823-840, Anaheim, CA, August 2023. USENIX Association.
[37] Carter Yagemann, Matthew Pruett, Simon P. Chung, Kennon Bittick, Brendan Saltaformaggio, and Wenke Lee. ARCUS: Symbolic root cause analysis of exploits in production systems. In 30th USENIX Security Symposium (USENIX Security 21), pages 1989-2006. USENIX Association, August 2021.
[38] U.S. Pat. No. 9,779,235B2

What is claimed:

1. A processor comprising:
one or more processing unit, each configured to execute CPU instructions for a software program or process; and
an instruction-level programmable processor probing circuit operatively coupled to at least one of the one or more processing unit to detect an instruction-level anomaly at a processing unit under monitor,
the instruction-level programmable processor probing circuit comprising:
one or more state-machine engines having a plurality of programmable states to detect the instruction-level anomalies performed by the one or more processing unit, each state-machine engine having (i) a state table and (ii) a digital logic circuit configured to employ contents of the corresponding state table,
wherein each state table has a plurality of rows or columns corresponding to monitored states for a computer program or process being executed by the processing unit under monitor, the state table having a set of states for a number of instruction-level anomaly, each state having a plurality of entries having content for a functional operation to be performed by the digital logic circuit,
wherein each digital logic circuit is configured, for each instruction cycle of the processing unit under monitor, to (i) execute a functional operation defined by the plurality of entries, or a portion thereof, for a given state of a given instruction-level anomaly and (ii) determine and transition to a next state in the state table once a transition condition is met, and
wherein the instruction-level programmable processor probing circuit is configured to output a signal for an instruction-level anomaly and/or trigger halt of execution of instructions by the respective processing unit upon detection of the instruction-level anomaly by the state-machine engine.

2. The processor of claim 1, wherein the instruction-level programmable processor probing circuit includes an i-state machine configured to monitor states of interest in the execution of the monitored program; and
a d-state machine for monitoring data values involved in the execution of a monitored program,
each of the i-state machine and d-data machine having a state table and digital logic circuit.

3. The processor of claim 1, wherein the instruction-level programmable processor probing circuit is configured as a multi-stage pipeline configured to operate in a continuous manner per instruction cycle for a CPU instruction in a data stream of CPU instructions, the multi-stage pipeline including:
a first stage circuit configured to fetch, in a given instruction cycle, a next CPU instruction from a state table of a state-machine engine in the one or more state-machine engines;
a second stage circuit configured to load, in the same given instruction cycle or in a next instruction cycle, a plurality of entries, or a portion thereof, for a given state of a given instruction-level anomaly to the digital logic circuit; and
a third stage circuit to execute, in the same given instruction cycle or within next two cycles, the digital logic circuit to execute a functional operation defined by the digital logic circuit and a plurality of entries, or a portion thereof, for a given state of a given instruction-level anomaly.

4. The processor of claim 1, wherein the instruction-level programmable processor probing circuit is configured to transition to a next state based on two or more conditions.

5. The processor of claim 4, wherein the instruction-level programmable processor probing circuit is configured to execute, for a branch CPU instruction, two evaluations of the two or more conditions for transition to the next state.

6. The processor of claim 1, wherein each of the plurality of rows or columns corresponding to monitored states for a computer program or process includes:
one or more transition conditions;
a next state definition; and
an action condition.

7. The processor of claim 1, wherein the one or more state-machine engines include at least two state-machine engines, wherein each of the state-machine engine is synchronized with one another.

8. The processor of claim 4, wherein the instruction-level programmable processor probing circuit is configured to monitor for invariant or consistent execution properties of a CPU instruction.

9. The processor of claim 1, wherein the instruction-level programmable processor probing circuit is configured to halt CPU operation of the processing unit under monitor within 3-5 instruction cycles of detection of the instruction-level anomaly by the state-machine engine and while the anomaly is being executed by the one or more processing unit.

10. The processor of claim 1, wherein the state table is implemented in register with the plurality of programmable states and plurality of entries having content for a functional operation stored in registers.

11. The processor of claim 10, wherein a portion of the plurality of entries is compressed and a remaining portion of the plurality of entries is not compressed.

12. The processor of claim 1, wherein the instruction-level programmable processor probing circuit is configured for a set of Common Vulnerabilities and Exposures (CVE) detections as the instruction-level anomaly.

13. The processor of claim 1, wherein the instruction-level programmable processor probing circuit is configured for a set of Common Weakness Enumeration (CWE) detections as the instruction-level anomaly.

14. The processor of claim 1, wherein the output signal for the instruction-level anomaly is employed for monitoring or model checking, detection, forensic and diagnostic, mitigation, recovery, or halt execution.

15. The processor of claim 1, wherein the one or more state-machine engines include duplicates of the state-machine engines, including a first i-state machine, a second i-state machine, a first d-state machine, and a second d-state machine, wherein each of the state-machine engines is synchronized with one another.

16. The processor of claim 1, wherein the digital logic circuit of the instruction-level programmable processor probing circuit includes:
a comparator coupled to a mask register and a value register;
a down counter circuit coupled to the comparator and a control register; and
an update action circuit coupled to the down counter circuit and configured to output a output value to a pointer of an action table, the action table being monitored to execute an action at the one or more processing units.

17. The processor of claim 3, wherein the multi-stage pipeline further includes:
a ring buffer coupled to an output of the third stage circuit; and
a direct memory access circuit coupled to the ring buffer, the direct memory access circuit being configured to output a data value to a memory controller.

18. A method comprising:
providing a processor, the processor comprising:
one or more processing unit, each configured to execute CPU instructions for a software program or process; and
an instruction-level programmable processor probing circuit operatively coupled to at least one of the one or more processing unit to detect an instruction-level anomaly at a processing unit under monitor,
the instruction-level programmable processor probing circuit comprising:
one or more state-machine engines having a plurality of programmable states to detect the instruction-level anomalies performed by the one or more processing unit, each state-machine engine having (i) a state table and (ii) a digital logic circuit configured to employ contents of the corresponding state table,
wherein each state table has a plurality of rows or columns corresponding to monitored states for a computer program or process being executed by the processing unit under monitor, the state table having a set of states for a number of instruction-level anomaly, each state having a plurality of entries having content for a functional operation to be performed by the digital logic circuit,
wherein each digital logic circuit is configured, for each instruction cycle of the processing unit under monitor, to (i) execute a functional operation defined by the plurality of entries, or a portion thereof, for a given state of a given instruction-level anomaly and (ii) determine and transition to a next state in the state table once a transition condition is met, and
wherein the instruction-level programmable processor probing circuit is configured to output a signal for an instruction-level anomaly and/or trigger halt of execution of instructions by the respective processing unit upon detection of the instruction-level anomaly by the state-machine engine,
loading a plurality of CPU instructions into the processor, the plurality of CPU instructions being executed by the first processing unit;
detecting, via one or more state-machine engines having the plurality of programmable states, one or more instruction-level anomalies in the plurality of CPU instructions; and
outputting a signal for an instruction-level anomaly and/or trigger halt of execution of the plurality of instructions by the first processing unit upon detection of the instruction-level anomaly by the state-machine engine.

19. A method for programming an instruction-level programmable processor probing circuit to detect an instruction-level anomaly at a processing unit, the method comprising:
providing one or more state machines describing CPU instructions for a software program of interest executed by the processing unit, wherein the one or more state machines includes one or more transition conditions, a next state definition, and an action condition;
converting states in the one or more state machines into programmable states (e.g., statelet) by translating references in the one or more state machines from source code locations to binary addresses, wherein the programmable states are linked via the one or more transition conditions; and
loading the programmable states into a state table of the processor probing circuit, wherein the state table has a plurality of rows or columns corresponding to monitored states for the software program of interest, the state table having a set of states for a number of instruction-level anomaly, each state having a plurality of entries having content for a functional operation to be performed (e.g., by a digital logic circuit).

20. The method of claim 19, wherein the loading of the programmable states into the state table comprises:
mapping each programmable state to a respective index of the state table (e.g., using a predefined mapping rule); and
determining state table indices for the programmable states for instruction-level (i-) and data-level (d-) monitoring for the software program of interest.

21. The method of claim 20, further comprising:
storing the mapping in a memory (e.g., of a device driver), the memory being operatively coupled to the processing unit; and
extracting the mapping from the memory to initiate monitoring of the software program of interest, in response to the software program of interest being subsequently launched.
